(19) United States
(12) Patent Application Publication
(10) Pub. No.: US 2022/0101431 A1
(43) Pub. Date: Mar. 31, 2022

(54) VIRTUAL-BOND COLLECTING DEVICE, COMPUTER READABLE MEDIUM AND VIRTUAL-BOND COLLECTING METHOD

(71) Applicant: MITSUBISHI ELECTRIC CORPORATION, Tokyo (JP)

(72) Inventors: Mitsuhiro MATSUMOTO, Tokyo (JP); Hiroshi YOKOCHI, Tokyo (JP); Daiki NAKASHIMA, Tokyo (JP)

(73) Assignee: MITSUBISHI ELECTRIC CORPORATION, Tokyo (JP)

(21) Appl. No.: 17/545,259

(22) Filed: Dec. 8, 2021

Related U.S. Application Data
(63) Continuation of application No. PCT/JP2019/029812, filed on Jul. 30, 2019.

(51) Int. Cl. G06Q 40/04; G06Q 20/06; G06Q 20/24

(52) U.S. Cl. CPC G06Q 40/04; G06Q 20/24; G06Q 20/065

(57) ABSTRACT

A smart contract (800) includes a bond issuing unit (832) and a bond collecting unit (833). The bond issuing unit (832) determines whether or not a payment amount to be paid by an exchange floor, who is a buyer, to a user, who is a seller, can be paid with a deposit amount of a deposit wallet of the exchange floor, and if the payment amount cannot be paid, issues to the user, a bond equivalent to a currency amount which is at least a part of the payment amount, stores the currency amount of the bond in a bond wallet, and registers the user in a creditor list. When there is currency-putting-in into the deposit wallet of the exchange floor, as the currency-putting-in becomes a trigger, the bond collecting unit (833) selects a creditor registered in the creditor list, and compares a put-in-currency amount with the currency amount of the bond which is issued to the creditor. When at least a part of the currency amount of the bond can be paid back with the put-in-currency amount, the bond collecting unit (833) pays back at least the part of the currency amount of the bond to the creditor with the put-in-currency amount.

### CROSS REFERENCE TO RELATED APPLICATIONS

This application is a Continuation of PCT International Application No. PCT/JP2019/029812, filed on Jul. 30, 2019, which is hereby expressly incorporated by reference into the present application.

### TECHNICAL FIELD

The present invention relates to a virtual-bond collecting device, which collects a virtual-bond, in a distributed ledger network.

### BACKGROUND ART

Conventionally, it has been impossible to make an exchange which requires more than one's own currency, by using virtual currency. When the exchange that requires more than one's own currency is executed, a transaction is not allowed, and thus, the exchange cannot be registered in blockchain.

On the other hand, the virtual currency has a system of its own currency which is called a token, and the token can be issued uniquely and sent to another person. There is a method of recording an exchange such as gold or stock by adding additional information to bitcoin called a colored coin which is the token. A method is proposed in which a securities exchange such as a bond or a bill is managed with blockchain by using a method of the colored coin (Patent literature 1 and 2).

Further, there is blockchain by which a program called a smart contract can be executed. It is possible to manage assets by using a token controlled by a program such as the smart contract.

For example, a method of managing intellectual property rights as the tokens has been proposed (Patent Literature 3).

### CITATION LIST

### Patent Literature

Patent Literature 1: JP2018-77714A

Patent Literature 2: JP2018-81498A

Patent Literature 3: JP2019-23843A

### SUMMARY OF INVENTION

### Technical Problem

By using the smart contract, it is possible to perform an exchange safely even if the exchange is between two unreliable people since the exchange can be controlled by a program. For example, when a user sells a commodity to an exchange floor, the user gives the commodity to the exchange floor, and the exchange floor pays currency. At this time, if the exchange floor does not pay the currency, the user cannot receive a compensation for the commodity.

In a case where the smart contract is used, the user can receive the compensation if the exchange floor deposits the currency in the smart contract in advance and payment from this deposit is automatically executed.

However, if the bond is not taken into consideration, the following problems arise.

(1) Since a selling order that is equal to more than a deposit cannot be accepted, the exchange floor needs to deposit in the smart contract, more currency than expected, and the deposited currency cannot be used for the other exchanges. Therefore, a cash flow is deteriorated.

(2) When a user places a selling order which is a large currency amount, the exchange floor needs to secure a deposit in order to contract the order, and cannot accept another user's selling order.

(3) Since the user can place a short-selling order in which commodities are not sold, an attack similar to DOS (Denial of Service attack) which is a cyber-attack is possible.

If payments are made not in order of ordering but in order of contracting, that is, in order in which commodity sales are completed, the above-described short selling problem (3) does not arise. However, since completion of the selling order cannot be guaranteed, a situation occurs in which the currency cannot be obtained even though the commodity has been given to the exchange floor, and the exchange cannot be performed with peace of mind.

A situation where the exchange successful is promised because the order is accepted, is preferable for users.

By adding a concept of a bond and issuing the bond even if there is a shortage of the currency, the above problems do not arise, and the exchange floor can succeed all exchanges.

On the other hand, conventionally, a method of managing the bond as the token (unique currency) has been proposed, but there exists no system for forcibly collecting the bond.

For this reason, even if the bond is issued when there is a shortage of virtual currency, there is no guarantee that the bond is returned as the virtual currency, and there has been a problem that a commodity exchange such as buying and selling of electricity with the virtual currency in which the bond is considered, cannot be realized.

The present invention aims to smoothly perform a commodity exchange using virtual currency.

### Solution to Problem

A virtual-bond collecting device according to the present invention includes:

a currency-putting-in detecting unit to detect currency-putting-in of virtual currency; and

a bond collecting unit to refer to creditor information in which a creditor that has a virtual bond which is electronic data is managed, and pay back to the creditor, at least a part of a currency amount indicated by the virtual bond when the currency-putting-in of the virtual currency is detected.

### Advantageous Effects of Invention

Since a virtual-bond collecting device of the present invention includes a bond collecting unit, a commodity exchange using virtual currency can be smoothly performed.

### BRIEF DESCRIPTION OF DRAWINGS

FIG. 1 is a network configuration diagram of a blockchain network 30, which is a diagram of a first embodiment.

FIG. 2 is a software configuration diagram of a user terminal 100 and an exchange floor terminal 400, which is a diagram of the first embodiment.

FIG. 3 is a functional configuration diagram of an ordering application 200, which is a diagram of the first embodiment.

FIG. 4 is a functional configuration diagram of a contracting application 600, which is a diagram of the first embodiment.

FIG. 5 is a functional configuration diagram of a smart contract 800, which is a diagram of the first embodiment.

FIG. 6 is a configuration diagram of data D100, which is a diagram of the first embodiment.

FIG. 7 is a hardware configuration diagram of a node 10, which is a diagram of the first embodiment.

FIG. 8 is a diagram illustrating a software configuration of the user terminal 100, which is a diagram of the first embodiment.

FIG. 9 is a diagram illustrating a software configuration of the exchange floor terminal 400, which is a diagram of the first embodiment.

FIG. 10 is a diagram illustrating a flow of currency in a buying order (F000), which is a diagram of the first embodiment.

FIG. 11 is a diagram illustrating a flow of currency in a selling order (F100), which is a diagram of the first embodiment.

FIG. 12 is a diagram illustrating a deposit (F) in an exchange floor, which is a diagram of the first embodiment.

FIG. 13 is a diagram illustrating a screen display by the ordering application 200, which is a diagram of the first embodiment.

FIG. 14 is a diagram illustrating a screen display by the ordering application 200, which is a diagram of the first embodiment.

FIG. 15 is a diagram illustrating a screen display by the contracting application 600, which is a diagram of the first embodiment.

FIG. 16 is a diagram illustrating a screen display by the contracting application 600, which is a diagram of the first embodiment.

FIG. 17 is a flowchart of a buying order process (F000), which is a diagram of the first embodiment.

FIG. 18 is a flowchart of a selling order process (F100), which is a diagram of the first embodiment.

FIG. 19 is a flowchart of a canceling process (F200), which is a diagram of the first embodiment.

FIG. 20 is a flowchart of a refunding process (F300), which is a diagram of the first embodiment.

FIG. 21 is a flowchart of a contracting process (F400), which is a diagram of the first embodiment.

FIG. 22 is a flowchart of a buying contract process (F500), which is a diagram of the first embodiment.

FIG. 23 is a flowchart of a selling contract process (F600), which is a diagram of the first embodiment.

FIG. 24 is a flowchart of a currency-putting-in process (F700), which is a diagram of the first embodiment.

FIG. 25 is a flowchart of a currency-taking-out process (F800), which is a diagram of the first embodiment.

FIG. 26 is a flowchart of an exchange setting process (F810), which is a diagram of the first embodiment.

FIG. 27 is a flowchart of a refund-for-creditor process (F900), which is a diagram of the first embodiment.

FIG. 28 is a diagram illustrating an example of issuance and collection of a bond, which is a diagram of the first embodiment.

FIG. 29 is a functional configuration diagram of a smart contract 800 including an applying unit 814, which is a diagram of a second embodiment.

FIG. 30 is a diagram illustrating a screen display by the applying unit 814, which is a diagram of the second embodiment.

FIG. 31 is a functional configuration diagram of an ordering application 200 including a history viewing unit 223, which is a diagram of a third embodiment.

FIG. 32 is a diagram illustrating an exchange managing terminal 900 connected to a blockchain network 30 which is a diagram of a fourth embodiment.

### DESCRIPTION OF EMBODIMENTS

Hereinafter, embodiments of the present invention will be described with reference to the drawings. Note that, in each drawing, the same reference numerals are assigned to the same or corresponding parts. In descriptions of the embodiments, for the same or corresponding parts, descriptions will be omitted or simplified as appropriate.

In the description of the embodiments below, a term, creditor, is used. The creditor means a user who is entitled to receive a refund by collection of a bond.

In the description of the embodiments below, a term, bond, is used. The bond used in the following embodiments is a virtual bond which is electronic data.

Note that, although “blockchain” is described in the following embodiments, the blockchain is an example of a distributed ledger that is electronic data. The following embodiments can be applied to the distributed ledger and a distributed ledger network that processes the distributed ledger. That is, a smart contract of the embodiments can be applied to the distributed ledger and the distributed ledger network that processes the distributed ledger.

### First Embodiment

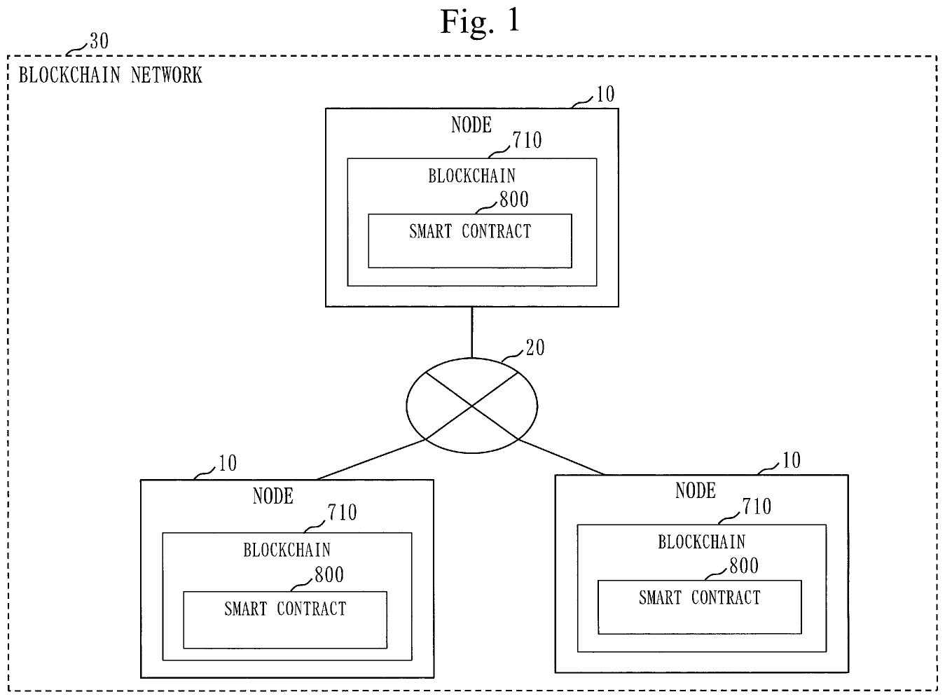

FIG. 1 is a network configuration diagram of a block chain network used in a first embodiment. Terminals called nodes 10 which are connected to the Internet 20 perform P2P communication and share data with each other. Networks that share blockchain 710 by using the P2P communication via the Internet 20 is called a blockchain network 30. The blockchain network 30 is used for virtual currency. The virtual currency includes virtual currencies such as Bitcoin and Ethereum. A major difference between Bitcoin and Ethereum is that Ethereum is characterized by having a function of a smart contract which is a program that operates on the blockchain 710.

Each node 10 has the blockchain 710 and a smart contract 800. The smart contract 800 is used in the blockchain 710. Data to be registered in the blockchain 710 can be controlled by the smart contract 800. Each node 10 operates on the premise that there is the blockchain 710 having the smart contract 800 such as Ethereum.

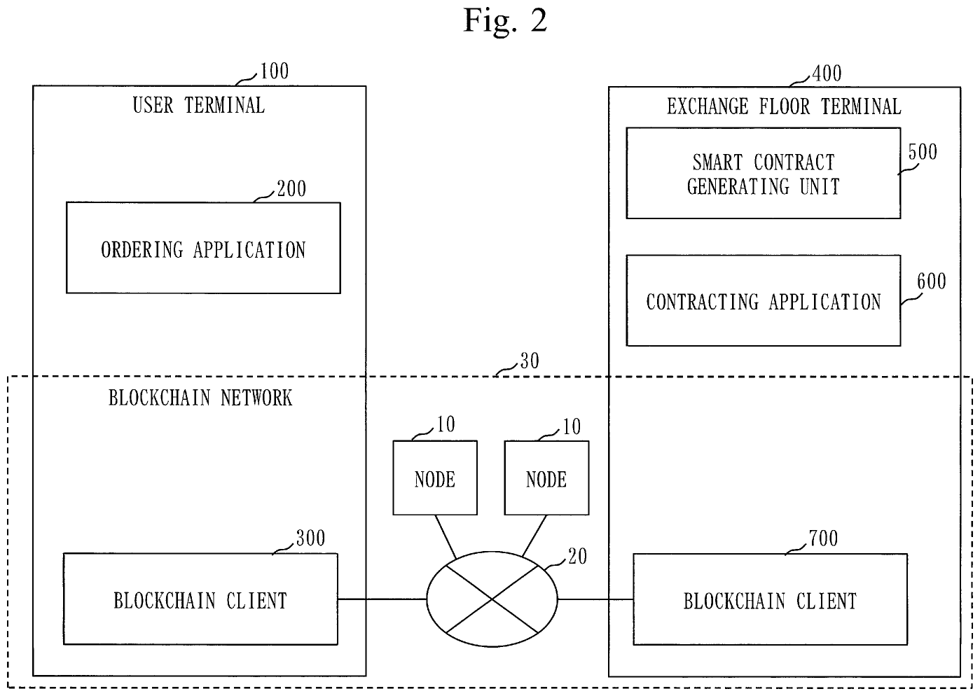

FIG. 2 is a software configuration diagram of a user terminal 100 and an exchange floor terminal 400 that perform a commodity exchange. A user who performs the commodity exchange has the user terminal 100. The exchange floor that performs the commodity exchange has the exchange floor terminal 400. The user terminal 100 and the exchange floor terminal 400 are connected to the Internet 20. As the node 10 in FIG. 1, the user terminal 100 and the exchange floor terminal 400 join the blockchain network 30. The user terminal 100 has two pieces of software that are an ordering application 200 and a blockchain client 300.

The exchange floor terminal 400 has two pieces of software which are a contracting application 600 and a blockchain client 700. Further, the exchange floor terminal 400 has a smart contract generating unit 500. The smart contract generating unit 500 generates the smart contract 800, compiles the smart contract 800, and registers the smart contract 800 in the blockchain 710 via the blockchain client 700. Generally, the smart contract 800 is developed in a smart contract development environment. The smart contract development environment is Remix or TruFFle when it comes to Ethereum.

The blockchain client 300 and the blockchain client 700 are pieces of software that constitute the blockchain network 30. The blockchain client 300 and the blockchain client 700 manage an account of the virtual currency, and share the blockchain 710 with another blockchain client.

The ordering application 200 is an application that places a selling and buying order of the commodity.

The contracting application 600 is an application by which the exchange floor contracts an order requested by the user.

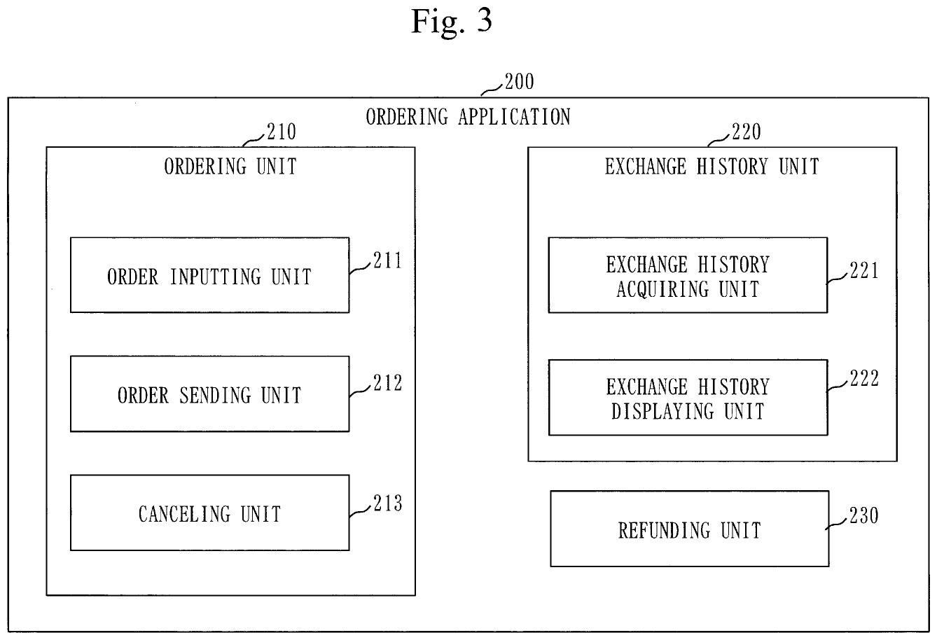

FIG. 3 is a functional configuration diagram of the ordering application 200 that the user uses when the commodity exchange is performed. The ordering application 200 that operates on the user terminal 100 includes an ordering unit 210 that processes an order, an exchange history unit 220 that handles an exchange history, and a refunding unit 230 that sends currency which has been refunded, to an account wallet of the user. The ordering unit 210 includes an order inputting unit 211 into which the user inputs order details, an order sending unit 212 that sends the input order details to the blockchain network 30, and a canceling unit 213 that cancels the order details. The exchange history unit 220 includes an exchange history acquiring unit 221 that acquires the exchange history from the blockchain 710, and an exchange history displaying unit 222 that displays the acquired exchange history.

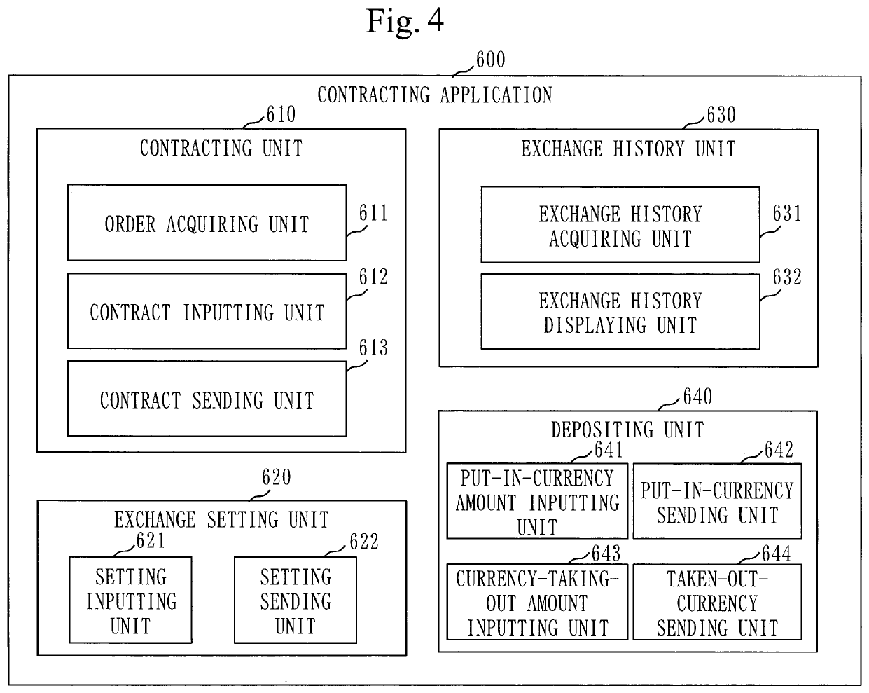

FIG. 4 is a functional configuration diagram of the contracting application 600 that the exchange floor uses when the commodity exchange is performed.

The contracting application 600 that operates on the exchange floor terminal 400 includes a contracting unit 610 that processes the contract, an exchange setting unit 620 that sets the exchange details, an exchange history unit 630 that handles the exchange history, and a depositing unit 640 that manages the deposit. The contracting unit 610 includes an order acquiring unit 611 that acquires the details of the order requested by the order application 200, a contract inputting unit 612 into which the details of the contract are input for the acquired order, and a contract sending unit 613 that sends to the blockchain network 30, the input contract details and executes the contract. The exchange history unit 630 includes an exchange history acquiring unit 631 that acquires the exchange history from the blockchain 710, and an exchange history displaying unit 632 that displays the acquired exchange history. The exchange setting unit 620 includes a setting inputting unit 621 into which pieces of setting information regarding an exchange such as a selling and buying cost and contract due time are input, and the setting sending unit 622 which sends the setting information to the blockchain network 30.

The depositing unit 640 includes a put-in-currency amount inputting unit 641, a put-in-currency sending unit 642, a currency-taking-cut amount inputting unit 643, and a taken-out-currency sending unit 644. The depositing unit 640 manages a deposit where the exchange floor prepares currency which is for payment corresponding to a commodity selling order from the user. In the put-in-currency amount inputting unit 641, the exchange floor inputs a payment amount. The put-in-currency sending unit 642 sends a put-in-currency amount to the blockchain network 30 in order to put in the input put-in-currency amount as a deposit.

In the currency-taking-out amount inputting unit 643, the exchange floor inputs the taken-out-currency amount for taking out the currency from the deposit. The taken-out-currency sending unit 644 sends the taken-out-currency amount to the blockchain network 30 for taking out the input taken-out-currency amount from the deposit.

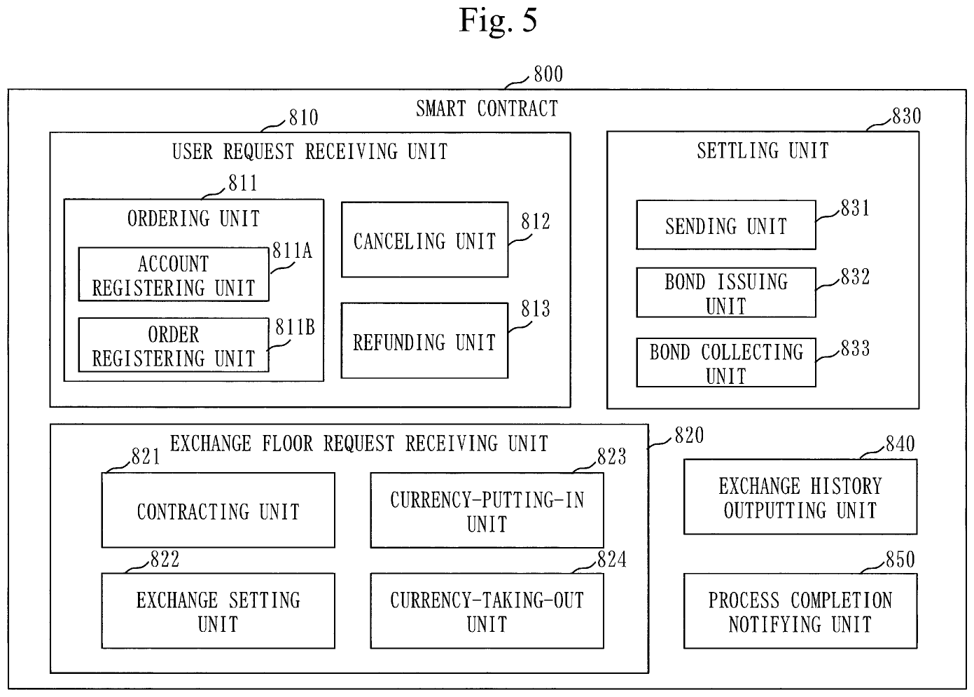

FIG. 5 is a functional configuration diagram of the smart contract 800 that controls the commodity exchange. The smart contract 800 generated by the smart contract generating unit 500 is sent to the blockchain network 30, and all commodity exchanges are controlled by the smart contract 800. The smart contract 800 includes a user request receiving unit 810, an exchange floor request receiving unit 820, a settling unit 830, an exchange history outputting unit 840, and a process completion notifying unit 850.

The user request receiving unit 810 receives a request from the user. The exchange floor request receiving unit 820 receives a request from the exchange floor. The settling unit 830 performs a settling process. The exchange history outputting unit 840 outputs the exchange history. The process completion notifying unit 850 notifies the ordering application 200 and the contracting application 600 of completion of processes such as an order registration and a contracting process.

The user request receiving unit 810 includes an ordering unit 811 that registers an order from the user, a canceling unit 812 that registers an order cancellation from the user, and a refunding unit 813 that sends a refunding amount to a wallet of the user corresponding to a refunding request from the user.

The ordering unit 811 includes an account registering unit 811A that automatically registers an account which is for a user who has placed an order for the first time, and an order registering unit 811B that registers an order of the registered account.

The exchange floor request receiving unit 820 includes: a contracting unit 821 that performs, when the exchange floor sends the contract corresponding to the registered order, a contracting process corresponding to the contract details; an exchange setting unit 822 that sets the exchange details corresponding to the exchange details that the exchange floor sets; a currency-putting-in unit 823 that sends to the deposit from the wallet of the user, currency of a put-in-currency amount that an exchange floor sets; and a currency-taking-out unit 824 that sends to the wallet of the user from the deposit, a taken-out-currency amount that the exchange floor sets.

The settling unit 830 includes a sending unit 831 that sends payment currency of a buyer to a seller, a bond issuing unit 832 that automatically issues a bond instead of the currency when the order is contracted with a selling cost which is more than the deposit for a selling order of the user, and a bond collecting unit 833 that automatically exchanges the issued bond for the currency by acquiring the currency by currency-putting-in of the exchange floor and a buying order contract of another user.

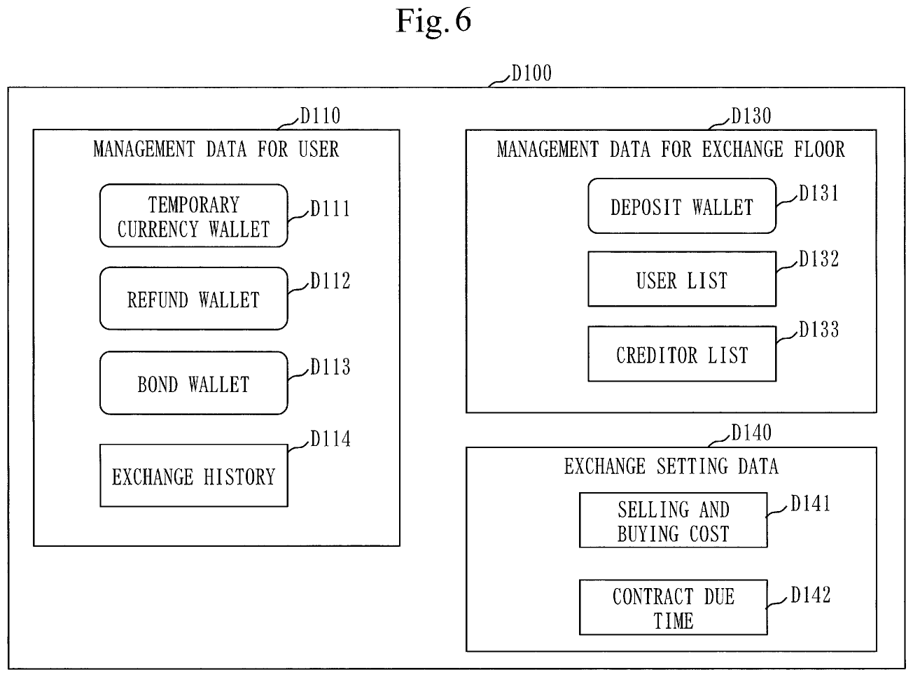

FIG. 6 illustrates a configuration of data D100 managed by the smart contract 800. Referring to FIG. 6, the data D100 managed by the smart contract 800 will be described. As management data D110 for the user, there are a temporary currency wallet D111, a refund wallet D112, a bond wallet D113, and an exchange history D114. The temporary currency wallet D111 is a place where a currency amount that the user pays when a buying order of the commodity is sent is stored temporally. The refund wallet D112 is a place where the change for the user, the selling price, and the like are stored. When the buying order is contracted, according to a contract amount, the currency is moved to a deposit wallet D131 from the temporary currency wallet D111, and the change is moved to the refund wallet D112.

Further, when the selling order is contracted, the currency is moved to the refund wallet D112 from the deposit wallet D131 so that the payment is made. The bond wallet D113 is a place where, when the selling order is contracted and the remaining amount of the deposit wallet D131 is a little and the selling price cannot be paid, the price that cannot be paid is recorded. The exchange history D114 is a place where the order details and the contract details of the user are recorded as a history. As management data for the exchange floor, there are the deposit wallet D131, a user list D132, and a creditor list D133. The deposit wallet D131 is a place where the currency put in by the exchange floor or the price paid by the user when the buying order is contracted is stored.

The user list D132 is a place where the user who has made the order is recorded. The creditor list D133 is a place where the user for which the bond is issued is recorded. Exchange setting data D140 records a selling and buying cost D141 and contract due time D142. The selling and buying cost D141 has a buying rate and a selling rate, and records data such as, for example, buying 30 Yen per 1 kwh and selling 25 Yen per 1 kwh. The contract due time D142 is data for setting due time which is until the order is contracted after the order is made, and after the contract due time is over, the exchange floor cannot contract, and the user can cancel the order.

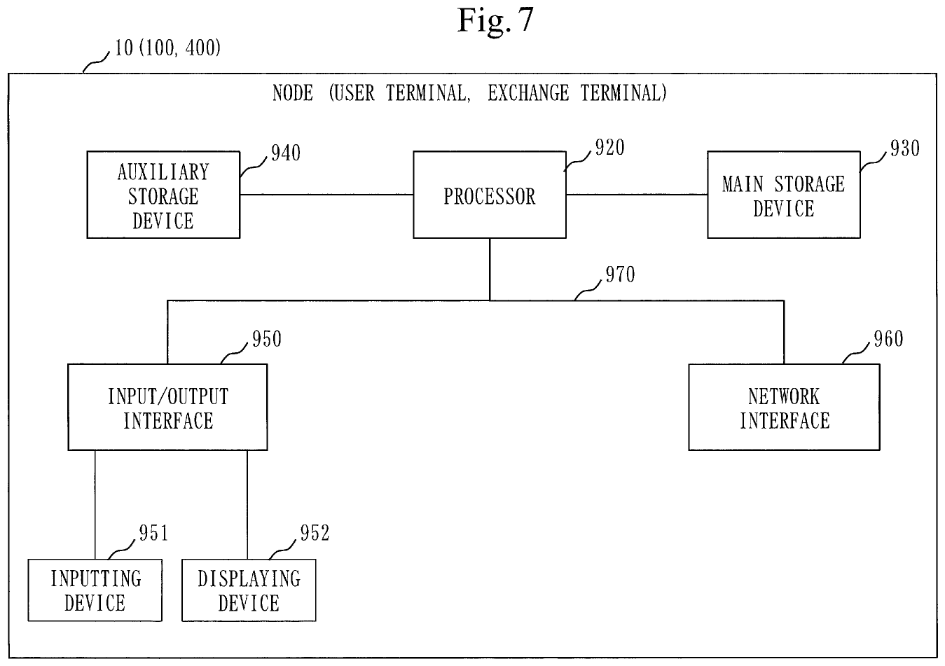

FIG. 7 illustrates a hardware configuration of the node 10. Since the nodes 10 are the user terminal 100 and the exchange floor terminal 400, FIG. 7 illustrates a hardware configuration of the user terminal 100 and the exchange floor terminal 400.

The node 10 is a computer. The node 10 includes a processor 920. The node 10 includes, in addition to the processor 920, other pieces of hardware such as a main storage device 930, an auxiliary storage device 940, an input/output interface 950, and a network interface 960. The processor 920 is connected to the other pieces of hardware via signal lines 170, and controls the other pieces of hardware.

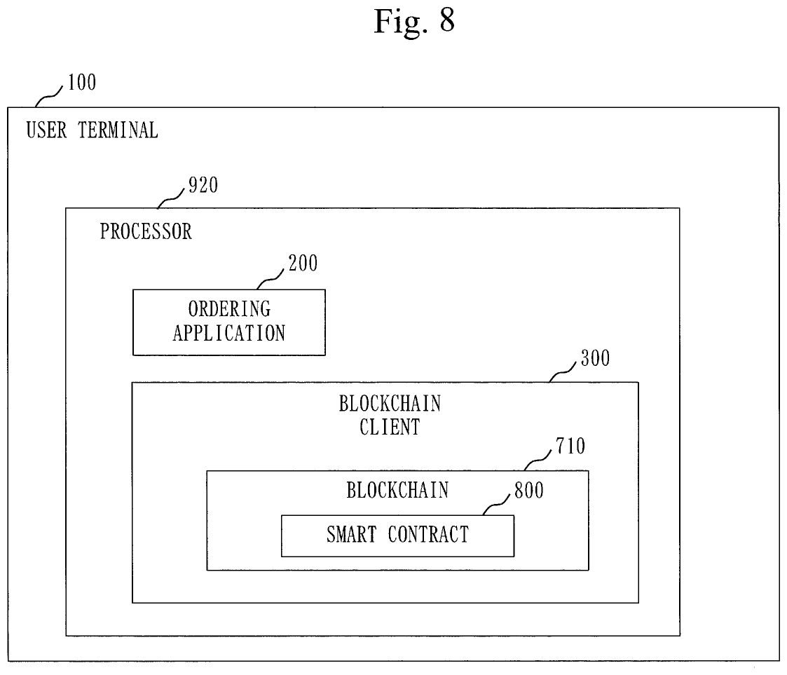

FIG. 8 illustrates a software configuration when the node 10 is the user terminal 100. When the node 10 is the user terminal 100, the user terminal 100 includes the ordering application 200 and the blockchain client 300 as programs. The blockchain client 300 includes the blockchain 710 and the smart contract 800. The smart contract 800 may be included in the blockchain 710 as a code, as illustrated in FIG. 8, or the smart contract 800 may be stored, by a method other than the blockchain 710, for example, as a file (hereinafter, smart contract file) in which a smart contract code is recorded. In a case of the smart contract file, it is necessary to share the smart contract file between the blockchain clients by using P2P or a cloud.

The processor 920 may execute the smart contract code registered in the blockchain via the blockchain client 300, or may execute the smart contract file directly.

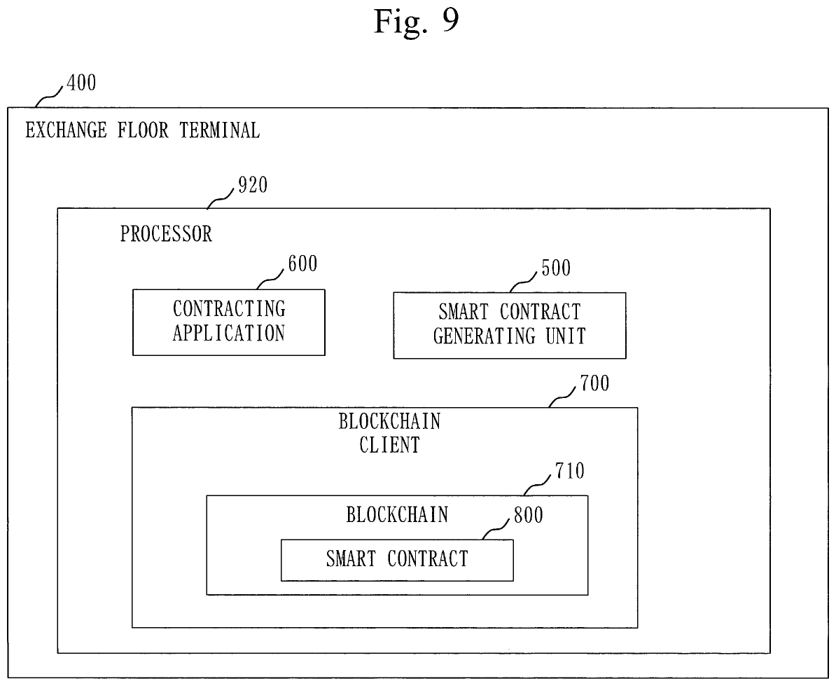

FIG. 9 illustrates a software configuration when the node 10 is the exchange floor terminal 400. When the node 10 is the exchange floor terminal 400, the exchange floor terminal 400 includes as programs, the smart contract generating unit 500, the contracting application 600, and the blockchain client 700. The blockchain client 700 includes the blockchain 710. The smart contract 800 may be included in the blockchain 710, or stored as the smart contract file. The processor 920 executes the smart contract generating unit 500, the contracting application 600, and the blockchain client 700. Since execution of the smart contract by the processor 920 is the same as a case of the user terminal 100, the descriptions are omitted.

The processor 920 is an IC (Integrated Circuit) that performs a calculating process. Specific examples of the processor 920 are a CPU (Central Processing Unit), a DSP (Digital Signal Processor), and a GPU (Graphics Processing Unit).

The main storage device 930 is a storage device. Specific examples of the main storage device 930 are an SRAM (Static Random Access Memory) and a DRAM (Dynamic Random Access Memory). The main storage device 930 holds a calculation result of the processor 920.

The auxiliary storage device 940 is a storage device that stores data in a non-volatile manner. A specific example of the auxiliary storage device 940 is an HDD (Hard Disk Drive). Further, the auxiliary storage device 940 may be a portable recording medium such as an SD (Registered Trademark) (Secure Digital) memory card, a NAND flash, a flexible disk, an optical disk, a compact disk, a Blu-ray (Registered Trademark) Disk, or a DVD (Digital Versatile Disk). When the node 10 is the user terminal 100, the auxiliary storage device 940 stores the ordering application 200, the blockchain client 300, and the smart contract 800. When the node 10 is the exchange floor terminal 400, the auxiliary storage device 940 stores the smart contract generating unit 500, the contracting application 600, the blockchain client 700, and the smart contract 800. The smart contract 800 is equivalent to a virtual-bond collecting program. The bond collecting program is a program which causes a computer to execute each process, each procedure, and each step which are obtained by reading as “process”, “procedure”, or “step”, “unit” of the currency-putting-in unit 823 which is a currency-putting-in detecting unit, the sending unit 831 which is the currency-putting-in detecting unit, the bond issuing unit 832, and the bond collecting unit 833.

The input/output interface 950 is a port through which the processor 920 inputs and outputs data from and to each device. The input/output interface 950 is connected to an inputting device 951 and a displaying device 952. The inputting devices 951 are devices such as a mouse and a touch panel.

The displaying device 952 is a device such as a liquid crystal display.

The node 10 may include a plurality of processors that substitute the processor 920. The plurality of processors share the execution of the program. Each processor is a device that executes a program in the same manner as the processor 920. A single processor and the plurality of processors are called processing circuitry. Functions of the ordering application 200 of the user terminal 100, the blockchain client 300, and the smart contract 800 are realized by the processing circuitry. Further, functions of the smart contract generating unit 500 of the exchange floor terminal 400, the contracting application 600, the blockchain client 700, and the smart contract 800 are realized by the processing circuitry.

The virtual-bond collecting program may be stored in a computer-readable recording medium and provided.

### Description of Operation

Next, operation will be described with reference to the drawings.

Operation, which is described below, of the smart contract 800 is operation of the smart contract 800 in the exchange floor terminal 400 which is a virtual-bond collecting device, and is further operation of the user terminal 100 which is the virtual-bond collecting device. This is because a method M executed by the smart contract 800 of the exchange floor terminal 400 is also executed by the smart contract 800 of the user terminal 100 in the same way. An operation procedure of the virtual-bond collecting device is equivalent to a virtual-bond collecting method. A program that realizes the operation of the virtual-bond collecting device is equivalent to the virtual-bond collecting program.

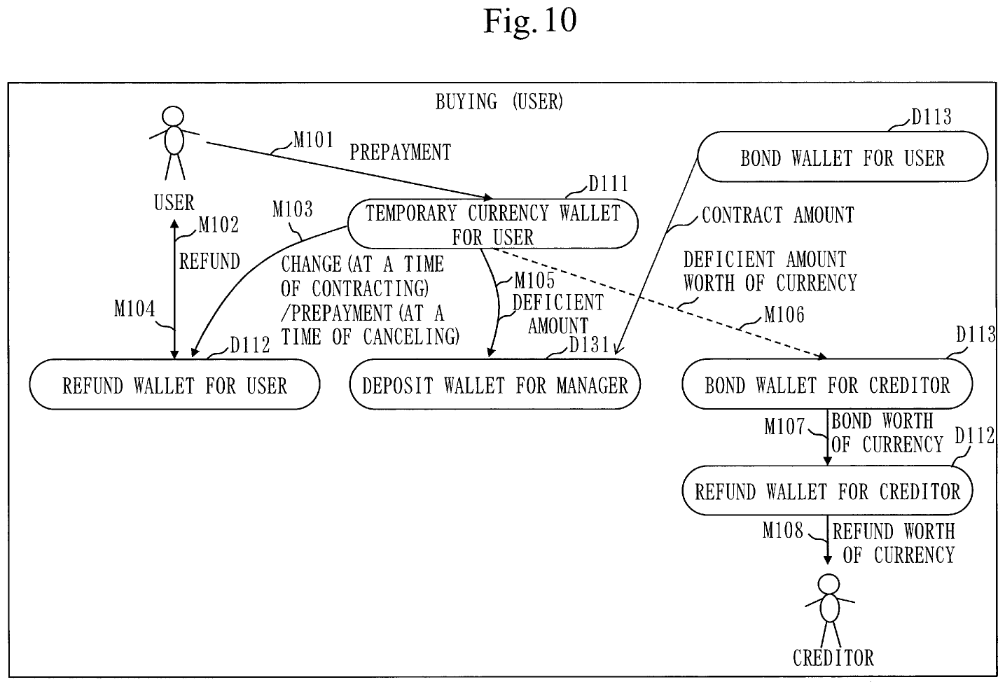

FIG. 10 is a diagram illustrating a flow of currency in a buying order (F000).

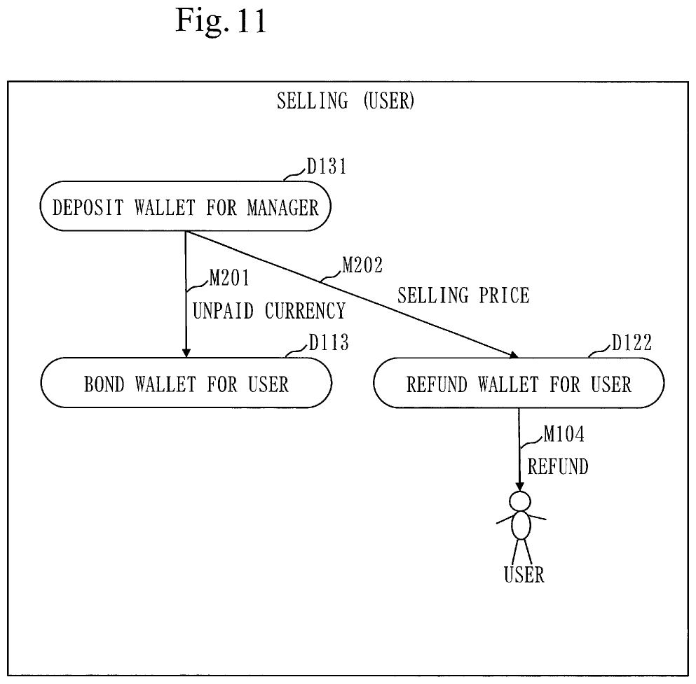

FIG. 11 is a diagram illustrating a flow of currency in a selling order (F100).

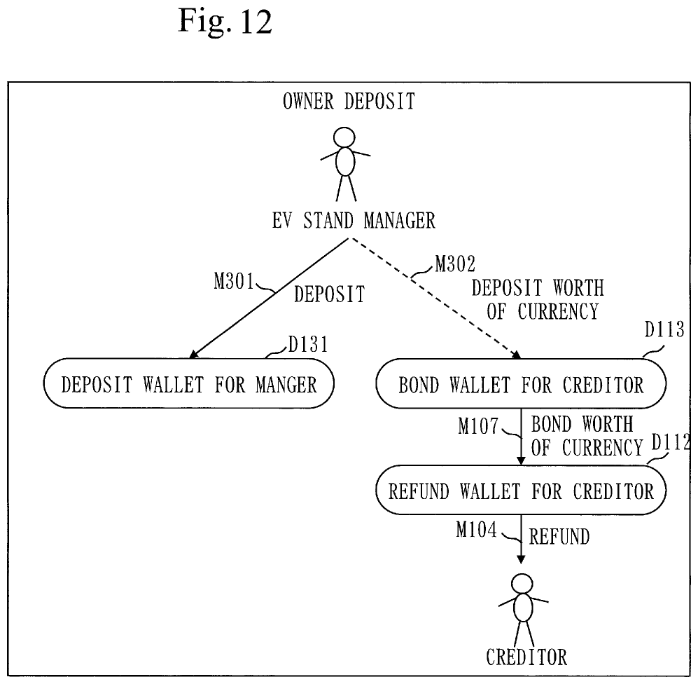

FIG. 12 is a diagram illustrating a deposit (F) in the exchange floor.

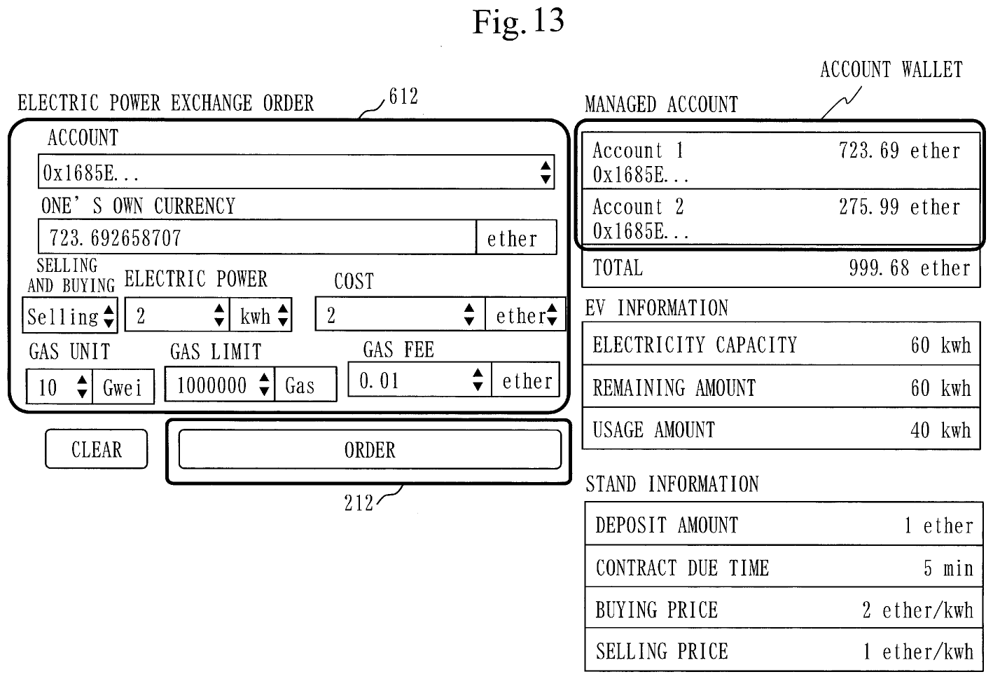

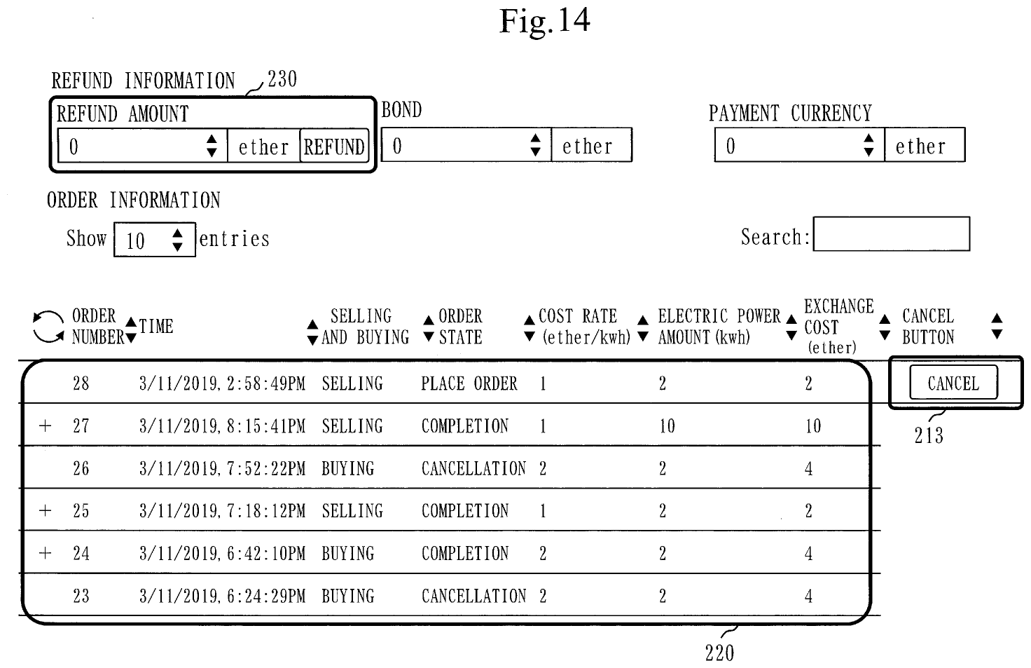

FIGS. 13 and 14 are diagrams illustrating screen displays by the ordering application 200.

Details of FIGS. 13 and 14 are displayed on one screen. FIG. 13 is an upper side of the screen, and FIG. 14 is a lower side of the screen.

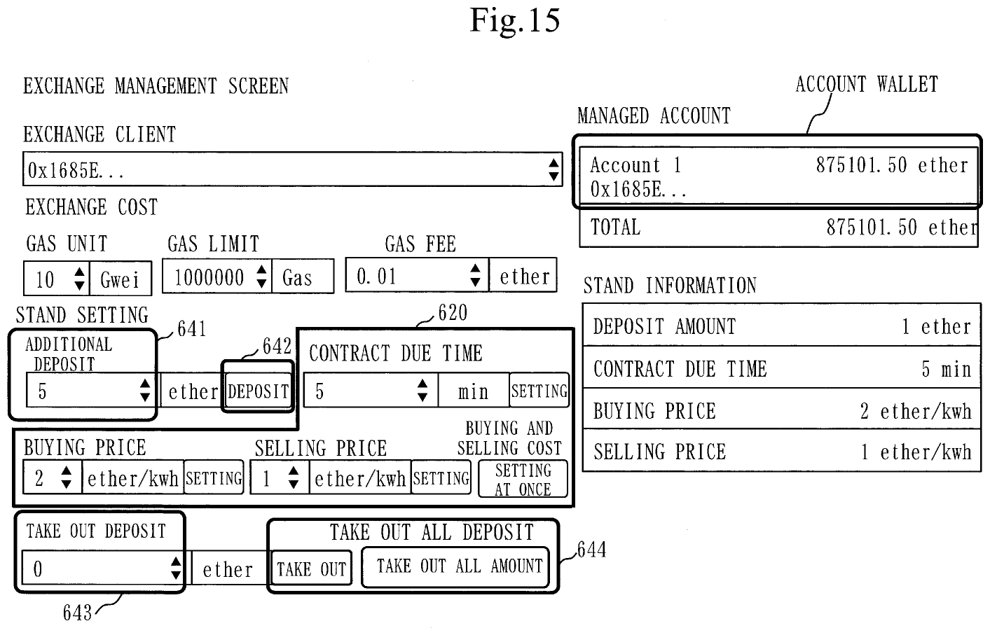

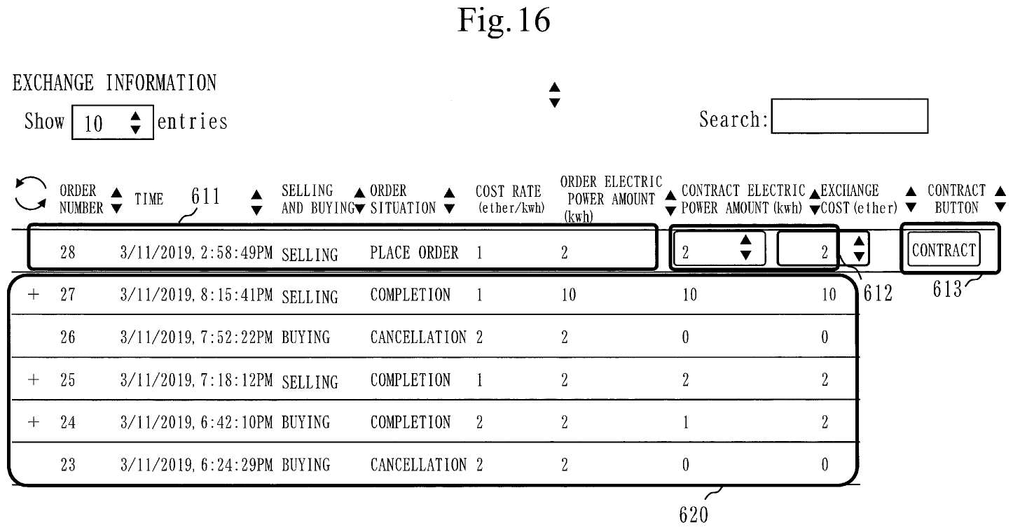

FIGS. 15 and 16 are diagrams illustrating screen displays by the contracting application 600.

Details of FIGS. 15 and 16 are displayed on one screen. FIG. 15 is an upper side of the screen, and FIG. 16 is a lower side of the screen.

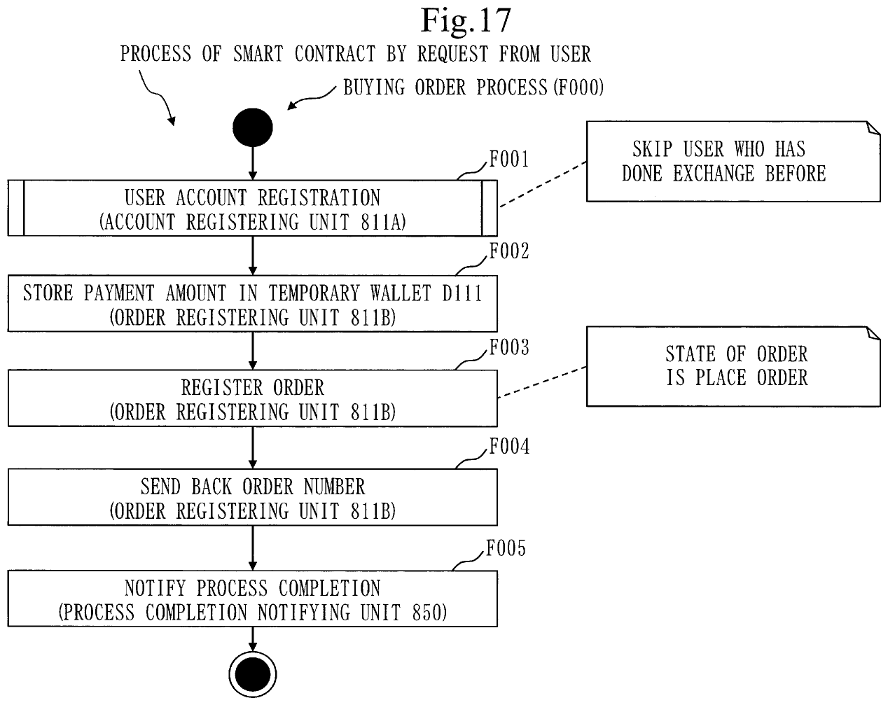

FIG. 17 is a flowchart of a buying order process (F000).

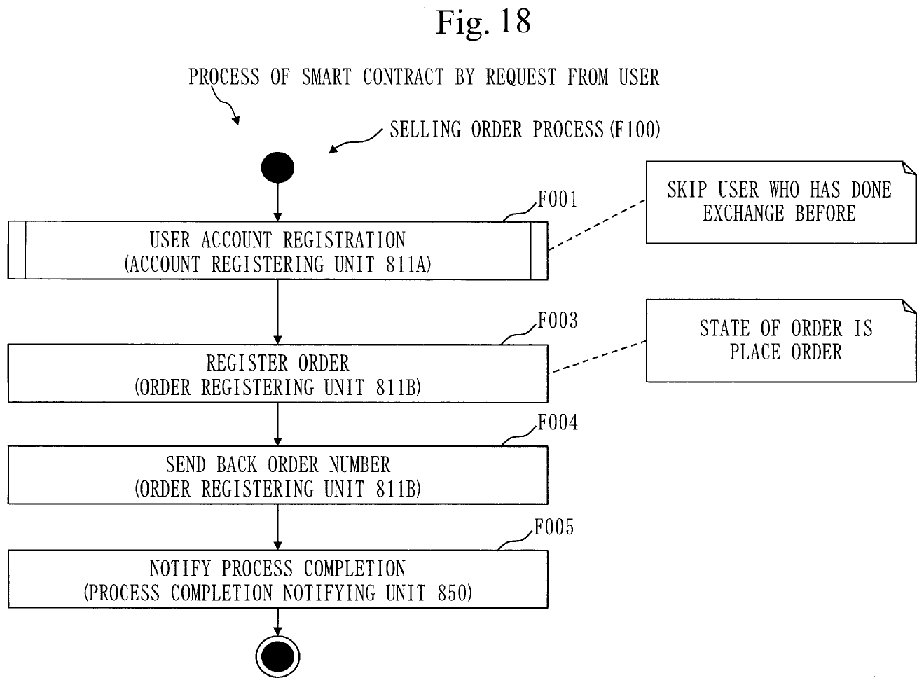

FIG. 18 is a flowchart of a selling order process (F100).

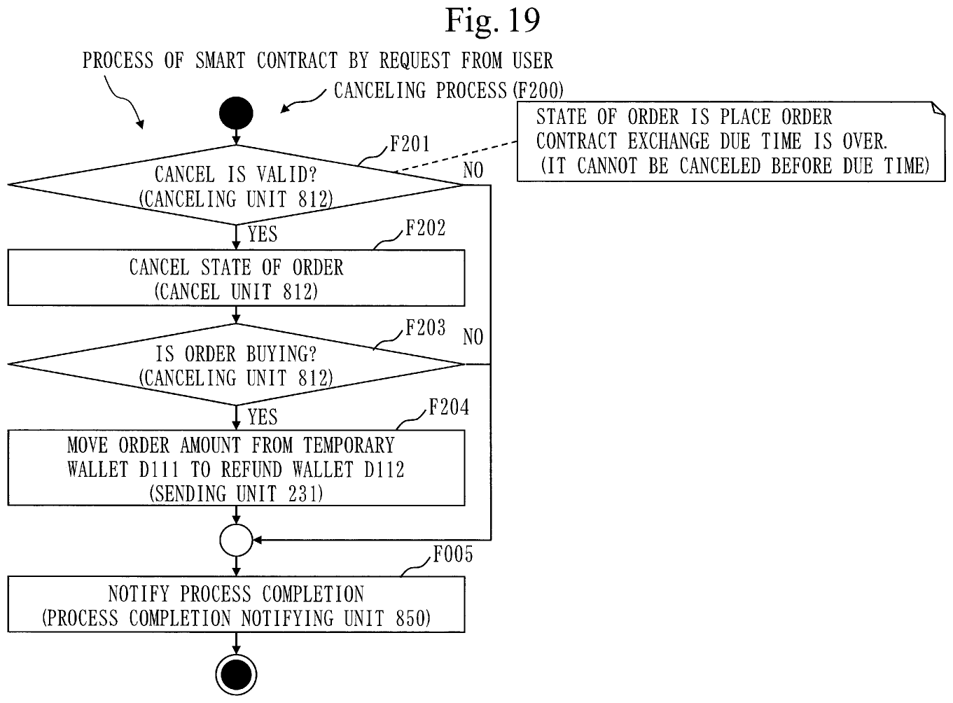

FIG. 19 is a flowchart of a canceling process (F200).

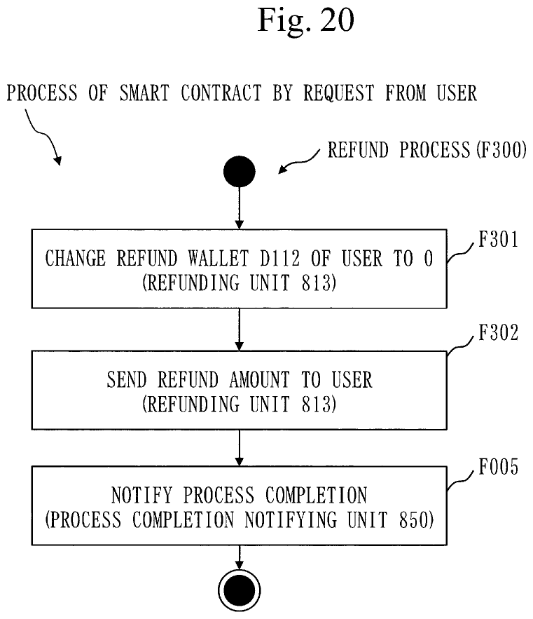

FIG. 20 is a flowchart of a refunding process (F300).

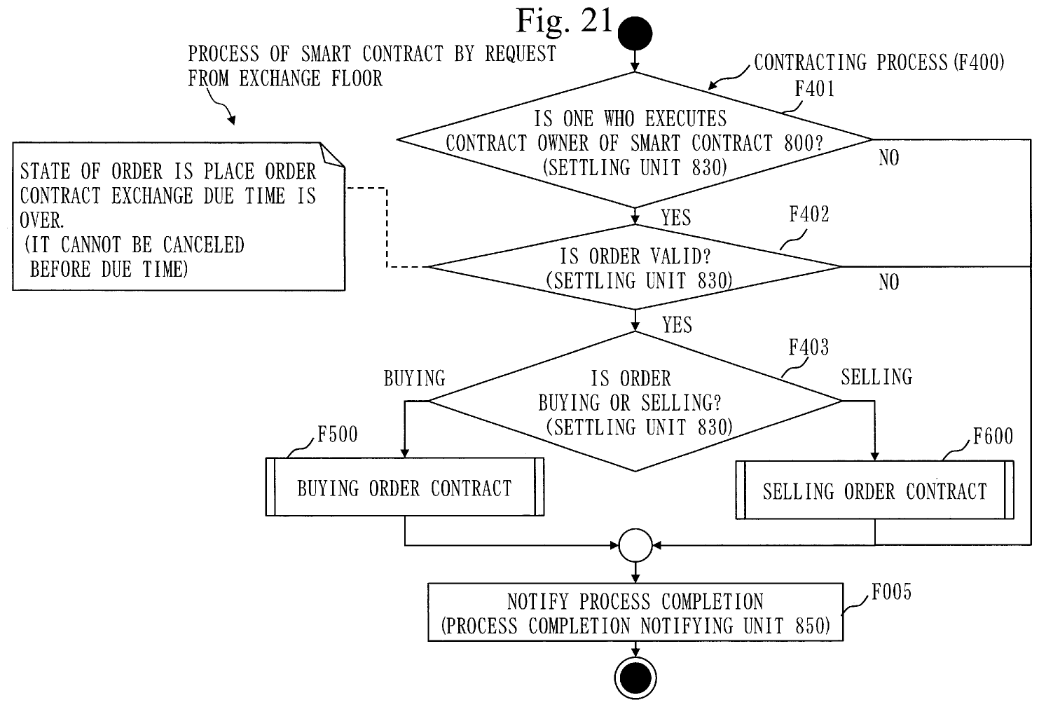

FIG. 21 is a flowchart of a contracting process (F400),

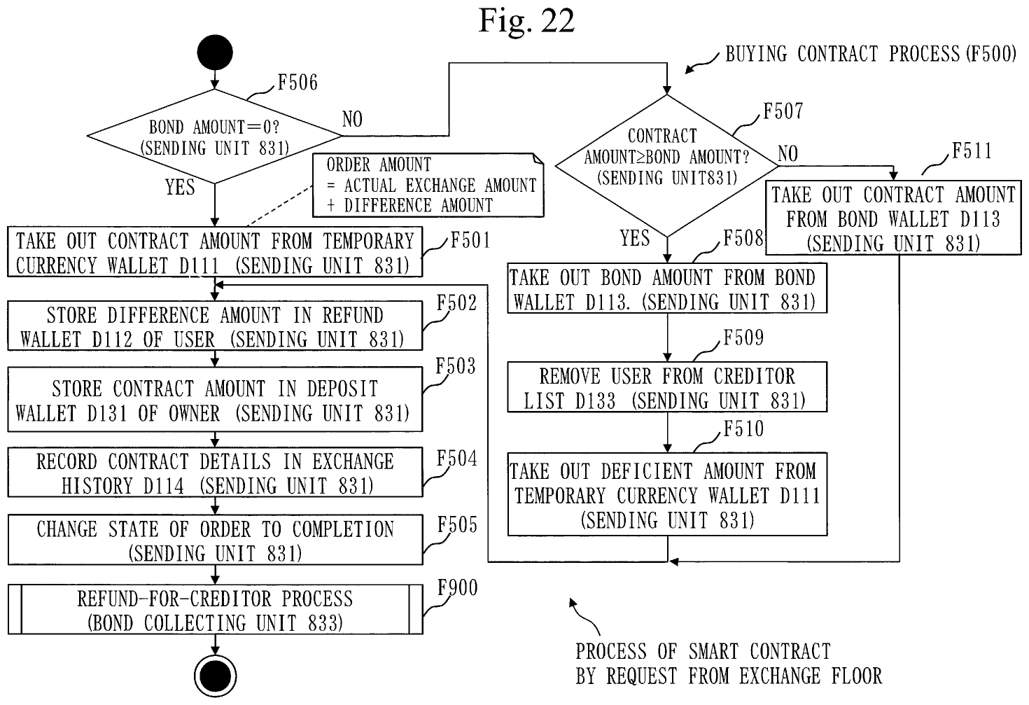

FIG. 22 is a flowchart of a buying contract process (F500).

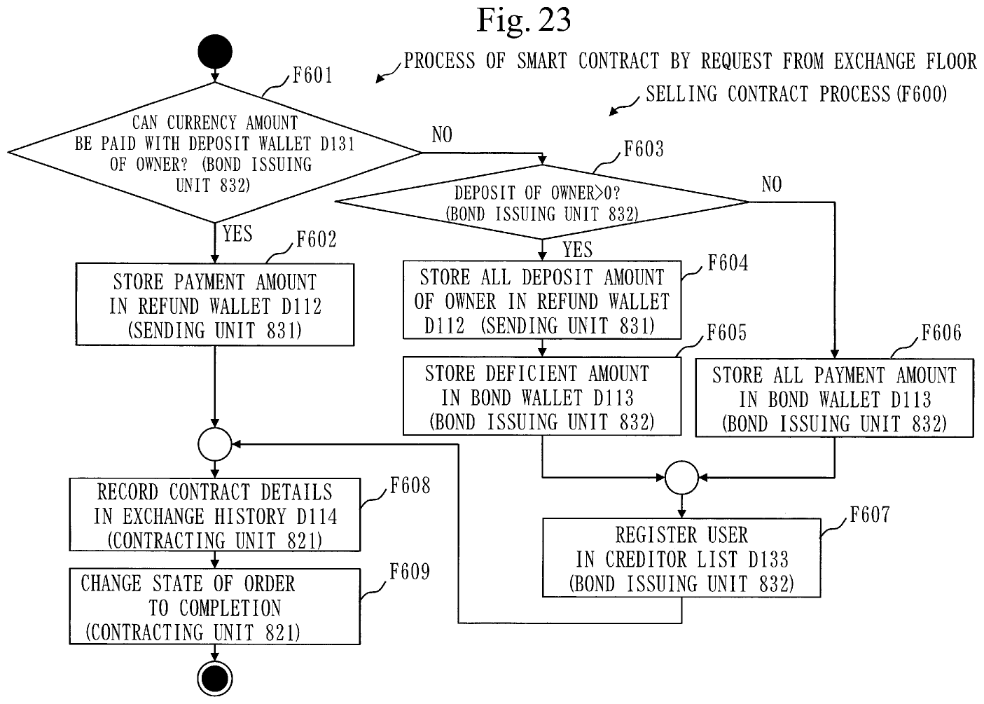

FIG. 23 is a flowchart of a selling contract process (F600).

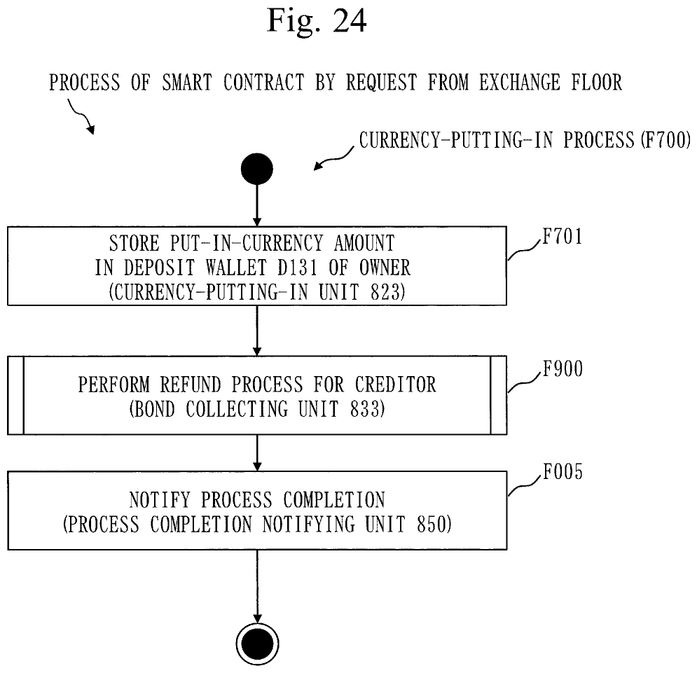

FIG. 24 is a flowchart of a currency-putting-in process (F700),

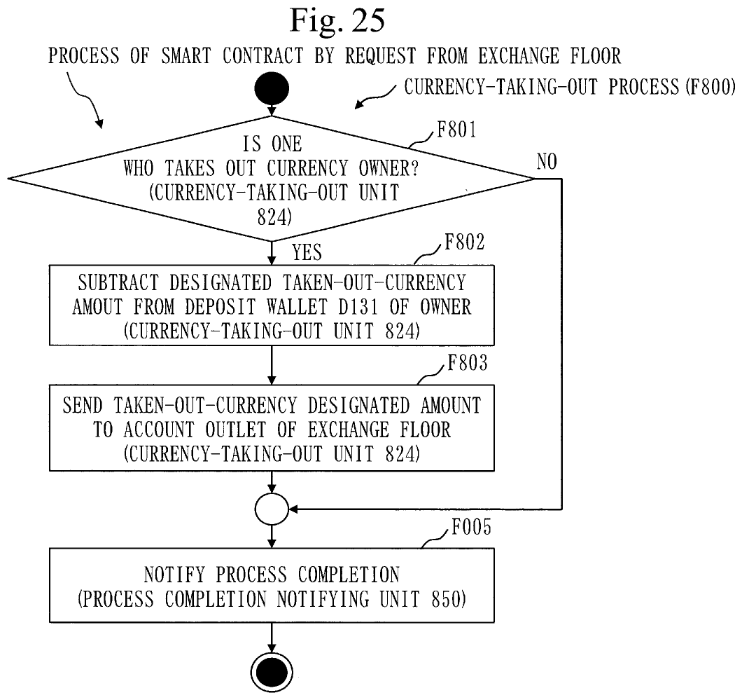

FIG. 25 is a flowchart of a currency-taking-out process (F800).

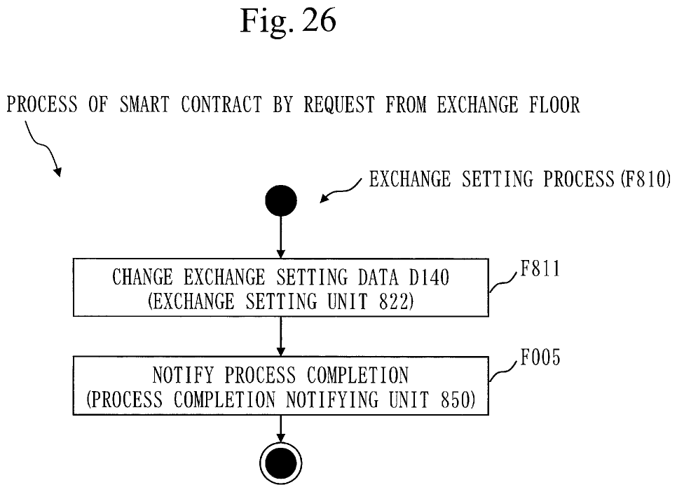

FIG. 26 is a flowchart of an exchange setting process (F810).

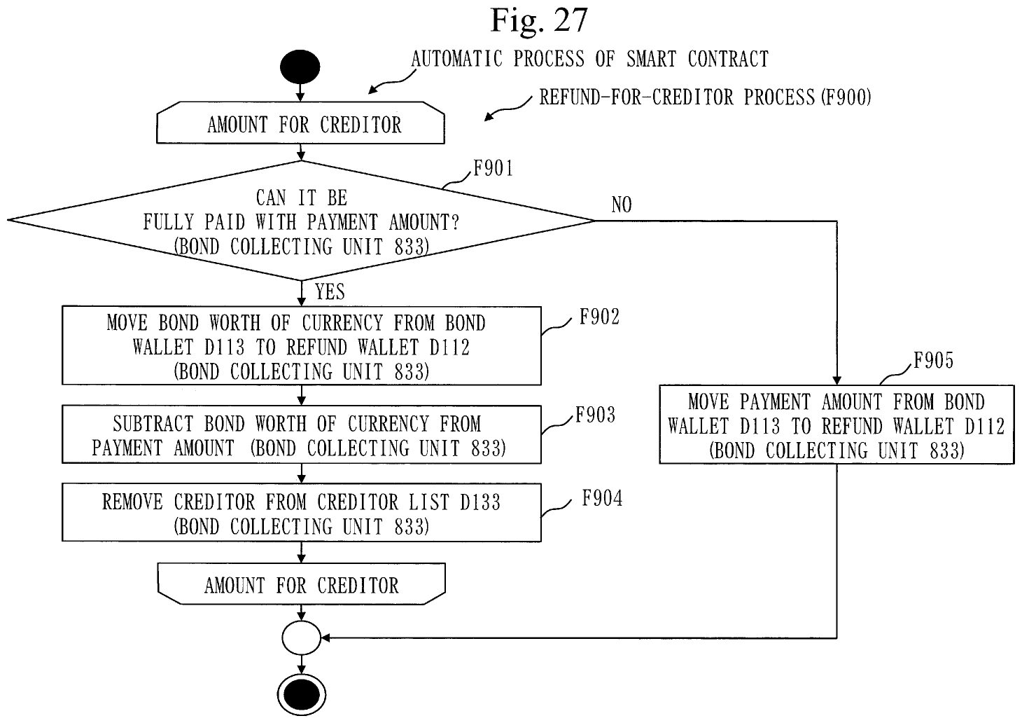

FIG. 27 is a flowchart of a refund-for-creditor process (F900).

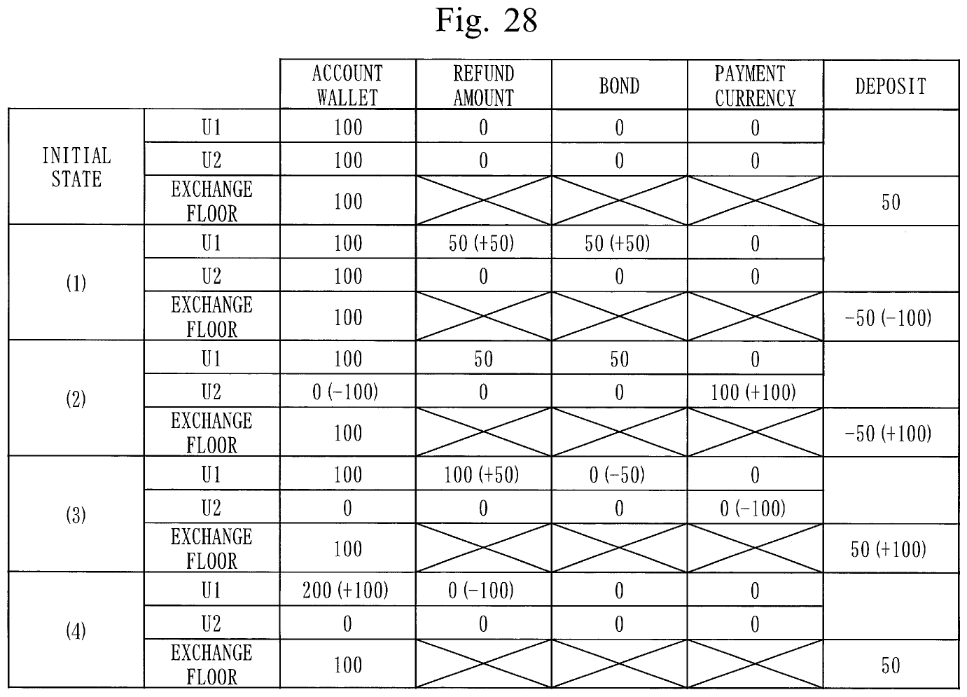

FIG. 28 is a diagram illustrating an example of issuance and collection of a bond.

### F000 and F100

With reference to FIGS. 10, 17, and 18, first, descriptions start from a time when the user starts the selling and buying exchange.

The user inputs into the order inputting unit 211 of the ordering application 200, order details such as “Buy 1,000 yen worth of electricity”. The order sending unit 212 sends the order details to the blockchain network 30. In a case of a buying order (F000), a price according to the order is sent.

In the blockchain network 30, the ordering unit 811 of the smart contract 800 processes the sent order. First, the account registering unit 811A of the ordering unit 811 determines whether or not the order is from an account that has made an order for the first time. If the order is from the account that has made the order for the first time, the account registering unit 811A adds the account to the user list D132 (F001). Further, the order registering unit 811B registers the order in association with the account (F003). Once the order registering unit 811B registers the order, the order registering unit 811B sends back the order number to the ordering application 200 of the user terminal 100 (F004). In a case of the buying order, since the currency is sent (F002), the order registering unit 811B stores in the temporary currency wallet D111 for the user, the currency as a prepayment (M101). A notification of process completion is sent to the ordering application 200 and the contracting application 600 by the process completion notifying unit 850 (F005).

### F400, F500, and F600

With reference to FIGS. 21, 22, and 23, a contracting process by the smart contract 800 will be described.

Operation when the exchange floor contracts the order of the user will be described. The contracting application 600 acquires the order details registered by the order acquiring unit 611. In the exchange floor, the contract inputting unit 612 receives the contract details based on the order details. Next, the contract sending unit 613 sends the contract details to the blockchain network 30. In the blockchain network 30, the settling unit 830 of the smart contract 800 performs a contracting process F400.

### F400

In the contracting process F400, if the exchange floor is the one (hereinafter, an owner of the smart contract 800) who registers the smart contract 800 in the blockchain, the settling unit 830 checks whether or not the one who executes the contract is the owner of the smart contract 800 (F401). Then, if the one who executes the contract is the owner of the smart contract 800, the settling unit 830 checks whether or not the order is valid (F402).

After that, if the order is the buying order (buying in F403), the settling unit 830 executes a buying contract process F500. If the order is a selling order (selling in F403), the settling unit 830 executes a selling contract process F600. Finally, the process completion notifying unit 850 sends the notification of the process completion to the ordering application 200 and the contracting application 600 (F005).

### F500

The sending unit 831 is the currency-putting-in detecting unit that detects currency-putting-in of the virtual currency.

The currency-putting-in detecting unit detects as the currency-putting-in of the virtual currency, currency-putting-in of the virtual currency that the exchange floor, who is a buyer, does for the user, who is a seller (F506), and currency-putting-in of the virtual currency for the deposit of the virtual currency by the exchange floor. The currency-putting-in of the virtual currency for the deposit of the virtual currency (F701) will be described later.

When the sending unit 831 detects the currency-putting-in of the virtual currency, in the buying contract process F500, the sending unit 831 of the smart contract 800 checks the bond in the bond wallet D113 for the user (F506). If the bond is 0 (YES in F506), the sending unit 831 takes out the contract amount from the temporary currency wallet D111 for the user (F501). If the bond is not 0 (NO in F506), the sending unit 831 compares the contract amount with the bond amount (F507). If the contract amount is equal to or more than the bond amount (YES in F507), the sending unit 831 takes out the bond amount from the bond wallet D113 for the user (F508), removes the user from the creditor list D133 (F509), and subtracts a deficient amount from the temporary currency wallet D111 (F510). If the contract amount is smaller than the bond amount (NO in F507), the sending unit 831 takes out the contract amount from the bond wallet D113 for the user (F511), the process proceeds to F502.

The sending unit 831 puts in the refund wallet D112 as change, an amount obtained by subtracting the contract amount from an order amount which is a cost difference (F502 and M103). The sending unit 831 puts in the deposit wallet D131, the contract amount (F503 and M105). After that, the sending unit 831 records the contract details in the exchange history D114 (F504), and changes a state of the order of the exchange details to “completion” (F505). In FIGS. 13 to 16, there are “place order”, “cancellation”, and “completion” as states of the orders of the exchange history unit 630. Finally, the bond collecting unit 833 makes a refund to the creditor according to the contract amount (M106) (F900, M107).

### F600

The selling contract process F600 will be described. The bond issuing unit 832 compares payment amount data indicating a payment amount to be paid to the user, who is a seller, from the exchange floor, who is a buyer, with deposit data indicating a deposit amount that the buyer owns. The bond issuing remit 832 issues the bond for the seller based on the comparison result, and registers in the creditor list D133 which is the creditor information, the seller for which the bond is issued. Below, details will be described.

In the selling contract process F600, the bond issuing unit 832 of the smart contract 800 checks whether or not the contract amount can be paid with the currency put in the deposit wallet D131. If the contract amount can be paid (YES in F601), the sending unit 831 moves the contract amount of currency to the refund wallet D112 of the user from the deposit wallet D131 (F602 and M202). If the deposit amount is deficient (NO in F601), the bond issuing unit 832 checks whether or not the deposit amount is larger than 0 (F603). If the deposit amount is larger than 0 (YES in F603), the sending unit 831 moves all the amount of the deposit wallet D131 to the refund wallet D112 in order to pay as much of a part of the contract amount as possible (F604 and M202). The bond issuing unit 832 issues a bond which is a deficient amount, and puts the bond in the bond wallet D113 (F605 and M201).

If the deposit amount is equal to or smaller than 0 (NO in F603), the bond issuing unit 832 issues the bond which is a deficient amount, and puts the bond in the bond wallet D113 (F606 and M201).

If the bond is issued in F605 or F606, the bond issuing unit 832 registers the creditor in the creditor list D133 (F607). After the above-described settlement is completed, the contracting unit 821 records the contract details in the exchange history D114 (F608), and changes the state of the order to the completion (F609).

As described in F605 or F606 above, the bond issuing unit 832 determines whether or not the payment amount data indicating the payment amount to be paid by the owner, who is a buyer, to the user, who is a seller, can be paid with deposit data indicating the deposit amount deposited in the deposit wallet of the buyer (F604). When the bond issuing unit 832 determines that the payment amount cannot be paid with the deposit data, the bond issuing unit 832 issues as bond data, a bond equivalent to a currency amount of at least a part of the payment amount for the seller, and stores the issued bond data in bond wallet of the seller for which the bond has been issued, among the bond wallet set for each user (F605 and F606). Then, the bond issuing unit 832 registers the seller fir which the bond has been issued, in the creditor list D133 (F607).

### F200

Next, with reference to FIG. 19, a canceling process F200 will be described. The user can cancel a selling and buying order that the user has placed. The user selects an order to be cancelled from the exchange history unit 220 of the ordering application 200, and executes the cancellation by using the canceling unit 213 of the ordering application 200 (F200). The canceling unit 213 of the ordering application 200 sends cancel details to the blockchain network 30.

In the blockchain network 30, the canceling unit 812 of the smart contract 800 checks whether or not the order can be canceled (F201). Specifically, if a state of the order is “place order” and over the contract due time, it is possible to cancel (YES in F201). If it is possible to cancel, the canceling unit 812 changes the state of the order to cancellation (F202), and checks “buying selling” of the order details (F203). If it is “buying” (YES in F203), the sending unit 831 moves the order amount from the temporary currency wallet D111 to the refund wallet D112 (F204 and M103). Finally, the process completion notifying unit 850 sends the notification of the process completion to the ordering application 200 and the contracting application 600 (F005).

### F300

Next, a refunding process F300 will be described with reference to FIG. 20, The user can send the refunded currency from the refund wallet D112 to the account wallet (M104). The account wallet is a wallet in which virtual currency that the user of the account can use freely is put. When the user executes the refund by using the refunding unit 230 of the ordering application 200, the refund details are sent to the blockchain network 30.

In the blockchain network 30, the refunding unit 813 of the smart contract 800 processes the refund (F300). Specifically, the refunding unit 813 changes a value of the currency of the refund wallet D112 to 0 (F301), and sends to the user, the currency which is in the refund wallet D112 (F302). Finally, the process completion notifying unit 850 sends the notification of the process completion to the ordering application 200 and the contracting application 600 (F005).

### F700

Next, a currency-putting-in process F700 of the exchange floor will be described with reference to FIG. 24. The exchange floor can put the currency in the deposit wallet D131 in advance in order to pay a selling price from the deposit wallet D131 corresponding to a selling exchange from the user. In the exchange floor, a put-in-currency amount is input into the put-in-currency amount inputting unit 641 of the contracting application 600, and the put-in-currency sending unit 642 sends a put-in-currency amount to the blockchain network 30.

The currency-putting-in unit 823 is the currency-putting-in detecting unit that detects currency-putting-in of the virtual currency. When the currency-putting-in unit 823 detects the currency-putting-in of the virtual currency, in the blockchain network 30, the currency-putting-in unit 823 of the smart contract 800 stores in the deposit wallet D131, the currency amount which has been put in (F701 and M301).

After that, the bond of the creditor is collected according to the deposit amount (F900). Finally, the process completion notifying unit 850 sends the notification of the process completion to the ordering application 200 and the contracting application 600 (F005).

### F800

Next, a currency-taking-out process F800 will be described with reference to FIG. 25. The exchange floor can take out currency that the exchange floor itself has put in or currency obtained by the selling and buying exchange. The exchange floor inputs a taken-out-currency amount into the currency-taking-out amount inputting unit 643 of the contracting application 600, and sends to the blockchain network 30, the taken-out-currency amount by using the taken-out-currency sending unit 644.

In the blockchain network 30, the currency-taking-out unit 824 of the smart contract 800 checks whether or not the one who takes out the currency is a subject exchange floor, that is whether or not the one who takes out the currency is the owner of the smart contract 800 (F801). That the one who takes out the currency is the subject exchange floor means that the one who takes out the currency is the owner of the smart contract 800. If the one who takes out the currency is the subject exchange floor (YES in F801), the currency-taking-out unit 824 subtracts the designated taken-out-currency amount from the deposit wallet D131 (F802), and sends the taken-out-currency amount to the account wallet of the exchange floor (F803). Finally, the process completion notifying unit 850 sends the notification of the process completion to the ordering application 200 and the contracting application 600 (F005).

### F810

Next, an exchange setting process F810 will be described with reference to FIG. 26. The exchange floor can set and change the selling and buying price and the contract due time which are exchange conditions. The exchange floor inputs setting details from the setting inputting unit 621 of the contracting application 600, and sends the setting details to the blockchain network 30 by using a setting sending unit 622.

In the blockchain network 30, the exchange setting unit 822 of the smart contract 800 sets the selling and buying cost D141 and the contract due time D142 of the exchange setting data D140 (F811). Finally, the process completion notifying unit 850 sends the notification of the process completion to the ordering application 200 and the contracting application 600 (F005).

### F900

Finally, a refund-for-creditor process F900 will be described with reference to FIG. 27.

The refund-for-creditor process F900 is a bond collecting process. The bond is automatically collected by the bond collecting unit 833 according to the currency-putting-in by the exchange floor or a payment amount by the buying exchange of the user.

When the currency-putting-in of the virtual currency is detected by the currency-putting-in unit 823 or the sending unit 831, the bond collecting unit 833 refers to the creditor list D133 in which the creditor having the bond is managed, and pays back to the creditor, at least a part of the currency amount indicated by the bond. The creditor list D133 is the creditor information. Below, details will be described.

The bond collecting unit 833 selects a creditor from the creditor list D133 which is creditor information, and pays back at least a part of the currency amount indicated by a virtual bond to the selected creditor (F901 to F905).

First, the bond collecting unit 833 checks whether or not one creditor can be fully paid back with a put-in-currency amount or a payment amount. If one creditor can be fully paid back (YES in F901), the bond collecting unit 833 moves the bond worth of currency from the bond wallet D113 to the refund wallet D112 (F902 and M102).

Next, the bond collecting unit 833 subtracts the bond worth of currency from the put-in-currency amount or the payment amount (F903), and removes from the creditor list D133, the creditor applicable to the bond collection (F904). The bond collecting unit 833 checks whether or not a next creditor can be fully paid back, based on the amount obtained by the above-described subtraction, that is the amount obtained by subtracting the bond worth of currency from the put-in-currency amount or the payment amount. By repeating this, the bond collecting unit 833 automatically collects the bond of the creditor.

If the put-in-currency amount or the payment amount cannot be fully paid back to the creditor (NO in F901), the bond collecting unit 833 moves the put-in-currency amount worth or the payment amount worth of currency from the bond wallet D113 to the refund wallet D112 (F905 and M107), the refund-for-creditor process is completed.

Here, the bond is collected for each creditor, but the bond may be collected by an order unit. Further, the order of collecting the bond is generally to collect in order of the registration of the creditors, but it may be any colleting order. For example, a method of collecting in order of a past usage frequency or a higher payment amount or a method of collecting by prioritizing a good member is considered.

As described above F900, when there is currency-putting-in into the deposit wallet (F503 and F701), as this currency-putting-in becomes a trigger, the bond collecting unit 833 selects one of the creditors registered in the creditor list D133, and compares the put-in-currency amount which is put in, with the currency amount indicated by the bond data which is issued to the selected creditor (F901). When at least a part of the currency amount indicated by the bond data can be paid back with the put-in-currency amount as a result of the comparison, the bond collecting unit 833 pays back at least the part of the currency amount indicated by the bond data to the selected creditor with the put-in-currency amount which has been put in (F902 and F905). The currency-putting-in which is the trigger for the bond collection is F503 and F701. The currency-putting-in into the deposit wallet is one of: a payment from the user, who is a buyer, to the user, who is a seller (F503); and a deposit by the owner (F701).

### Effect of First Embodiment

Regarding the bond issued by the exchange floor, usually, the exchange floor performs the bond collecting process later so that the user can acquire the bond worth of currency. However, conventionally, there is a problem that the user cannot acquire the currency unless the exchange floor does the bond collecting process.

In the first embodiment, the smart contract 800 automatically executes the bond collecting process at the timing at which the exchange floor acquires the currency (F503 of a buying order and F701 of currency-putting-in of a deposit) so that the user can acquire the currency regardless of intention of the exchange floor.

The bond collecting process automatically starts regardless of the intention of the exchange floor as F503 of the buying order and F701 of the currency-putting-in of the deposit become a trigger.

Then, the creditor can collect the bond by someone else's exchange. That is, when the user U1 is the creditor, the buying contract of the buying order by the user U2 is decided, and there is the currency-putting-in into the deposit wallet D131 of the owner in F503. The user U2 may or may not be the creditor. The bond collecting unit 833 of the smart contract 800 can use the put-in-currency from the user U2 for the bond collection from the user U1.

As described above, since the bond is issued when the deposit is deficient, it is possible to obtain following effects.

(1) It is possible to prevent the exchange from stopping due to the deposit deficient. That is, it is possible to improve availability of the exchange.

(2) The exchange floor does not need to concern the deposit deficient and to put in more currency than necessary. That is, it is possible to attempt improvement of a cash flow.

(3) It is possible to prevent hindrance by the short selling by the user, which stops the selling exchange. That is, it is possible to revoke a malicious order.

Further, it is possible to obtain following effects by forcedly using for the bond collection, the currency obtained by the buying-exchange of another user or the currency-putting-in by the exchange floor.

(4) The user can perform the selling exchange with peace of mind. That is, it is possible to improve reliability of the exchange.

(5) The exchange floor does not need to care about the refund for the creditor. That is, it is possible to reduce a management burden.

FIG. 28 illustrates issuance and collection of the bond by a specific example. The issuance and collection of the bond will be described with specific examples with reference to FIG. 28. In the following descriptions, the user U1, the user U2, and the exchange floor are described.

### Initial State

The initial state is as following.

Account wallet of user U1: 100 Yen,

Refund amount: 0 Yen,

Bond: 0 Yen,

Payment amount: 0 Yen.

Account wallet of user U2: 100 Yen,

Refund amount: 0 Yen,

Bond: 0 Yen,

Payment amount 0 Yen.

Account wallet of exchange floor: 100 Yen,

Deposit amount: 50 Yen.

(1) The user U1 has placed a selling order which is 100 Yen worth of commodity, and the exchange floor has contracted 100 Yen.

A state of (1) is as following.

Account wallet of user U1: 100 Yen,

Refund amount: 50 Yen (+50),

Bond: 50 Yen (+50),

Payment amount: 0 Yen.

Account wallet of user U2: 100 Yen,

Refund amount: 0 Yen,

Bond: 0 Yen,

Payment amount: 0 Yen.

Account wallet of exchange floor: 100 Yen,

Deposit amount: −50 Yen (−100).

(2) The user U2 has placed a buying order which is 100 Yen worth of commodity.

A state of (2) is as following.

Account wallet of user U1: 100 Yen,

Refund amount: 50 Yen,

Bond: 50 Yen,

Payment amount: 0 Yen.

Account wallet of user U2: 0 Yen (−100),

Refund amount: 0 Yen,

Bond: 0 Yen,

Payment amount: 100 Yen (+100).

Account wallet of exchange floor: 100 Yen,

Deposit amount: −50 Yen.

(3) The exchange floor contracts a buying order of user U2 which is 100 Yen worth.

A state of (3) is as following.

Account wallet of user U1: 100 Yen,

Refund amount: 100 Yen (+50),

Bond: 0 Yen (−50),

Payment amount: 0 Yen.

Account wallet of user U2: 0 Yen,

Refund amount: 0 Yen,

Bond: 0 Yen.

Payment amount: 0 Yen (−100).

Account wallet of exchange floor: 100 Yen,

Deposit amount: 50 Yen (+100).

(4) The user U1 executes the refund.

A state of (4) is as following.

Account wallet of user U1: 200 Yen (+100),

Refund amount: 0 Yen (−100),

Bond: 0 Yen,

Payment amount: 0 Yen.

Account wallet of user U2: 0 Yen,

Refund amount: 0 Yen,

Bond: 0 Yen,

Payment amount: 0 Yen.

Account wallet of exchange floor: 100 Yen,

Deposit amount: 50 Yen.

The user U1 has sold 100 Yen worth of commodity, and the user U2 has bought 100 Yen worth of commodity. For this reason, finally, the account wallet of the user U1 has increased by 100 Yen, the account wallet of the user U2 has decreased by 100 Yen, and there is no change in the exchange floor.

### Second Embodiment

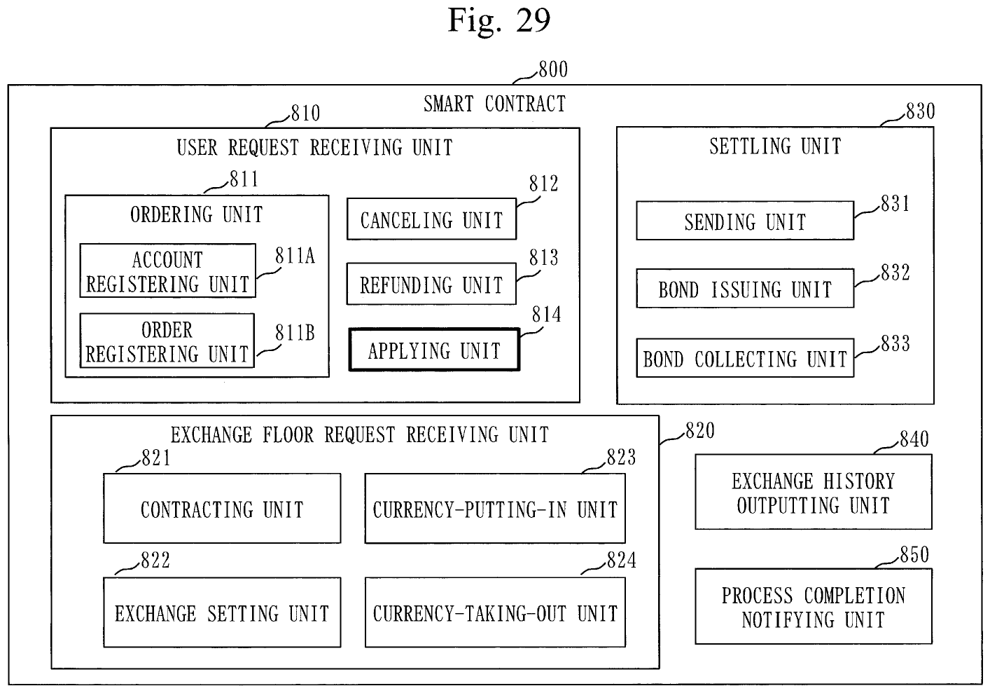

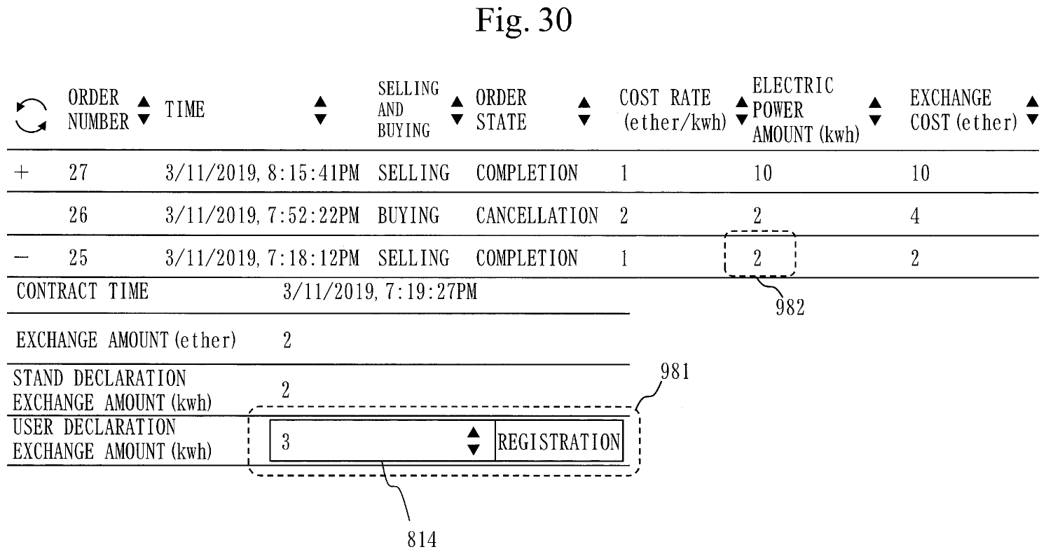

The second embodiment will be described with reference to FIGS. 29 and 30.

FIG. 29 illustrates a configuration in which the user request receiving unit 810 of the smart contract 800 includes an applying unit 814 that receives an application of the exchange details.

FIG. 30 illustrates a screen display of the applying unit 814.

In addition to the above first embodiment, the smart contract 800 may include the applying unit 814 by which the user can record the exchange details.

The applying unit 814 acquires the application of the exchange details from the ordering application 200 of the user, and writes the acquired application into the blockchain 710 which is the distributed ledger which is electronic data. The applying unit 814 is a writing unit.

FIG. 30 illustrates an application screen which the applying unit 814 displays on the displaying device 952 of the user terminal 100. If the user side registers a genuine transaction volume by the applying unit 814, it is possible to pursue the fraud of the exchange floor. FIG. 30 illustrates that it is recorded that although the user has provided 3 kwh of electric power illustrated in a frame 981 for the exchange floor, the exchange floor has received only 2 kwh indicated by a frame 982. For this reason, the user has been paid for smaller amount than an amount that the user is actually entitled to be paid for. Therefore, the user can record that there has been an exchange equivalent to 3 kwh, and clarify a fraudulent exchange.

### Third Embodiment

In the second embodiment, the user registers the exchange details so that the fraudulent exchange is exposed. However, it is impossible to find which one of the user and the exchange floor registers an untrue exchange by only having one piece of data. Therefore, the history viewing unit 223 that can view information such as a history of an exchange with a user other than oneself or a deposit history of the exchange floor, may be added so that the user and the exchange floor can exchange with peace of mind.

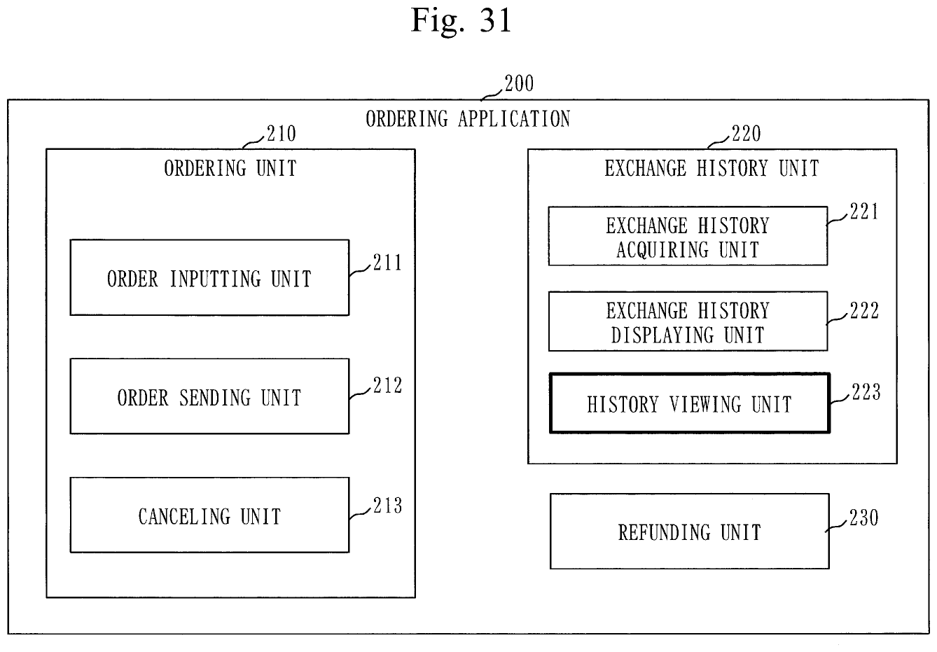

FIG. 31 illustrates a configuration in which the exchange history unit 220 of the ordering application 200 has the history viewing unit 223.

Since, by the history of the exchange with the user other than oneself, it is possible for a user who uses the exchange floor for the first time to know whether or not the exchange floor has not made an untrue declaration or how many exchanges are made every day, the history of the exchange is a barometer for measuring the reliability of the exchange floor.

The deposit history of the exchange floor is a barometer of how quickly bonds are collected during a selling exchange. In the history viewing unit 223, of course, each exchange history can be viewed, and also the history viewing unit 223 may have an index for quantitatively evaluating based on the number of discrepancies and a degree of divergence of the exchange details between the user and the exchange floor, in the similar manner as EC site reviews.

According to the third embodiment, there is an effect that the user can select the exchange floor based on the reliability of the exchange floor in such a manner that the history viewing unit 223 indicates the deposit history and the exchange history to the user.

### Fourth Embodiment

In the first embodiment, the exchange has been performed by two who are the user and the exchange floor. Since the small contract 800 is generated by the exchange floor, the user needs to evaluate whether or not the exchange floor generates a valid smart contract 800.

However, since it is not easy to decode a program of the smart contract 800, it is difficult to evaluate whether or not the smart contract 800 is valid.

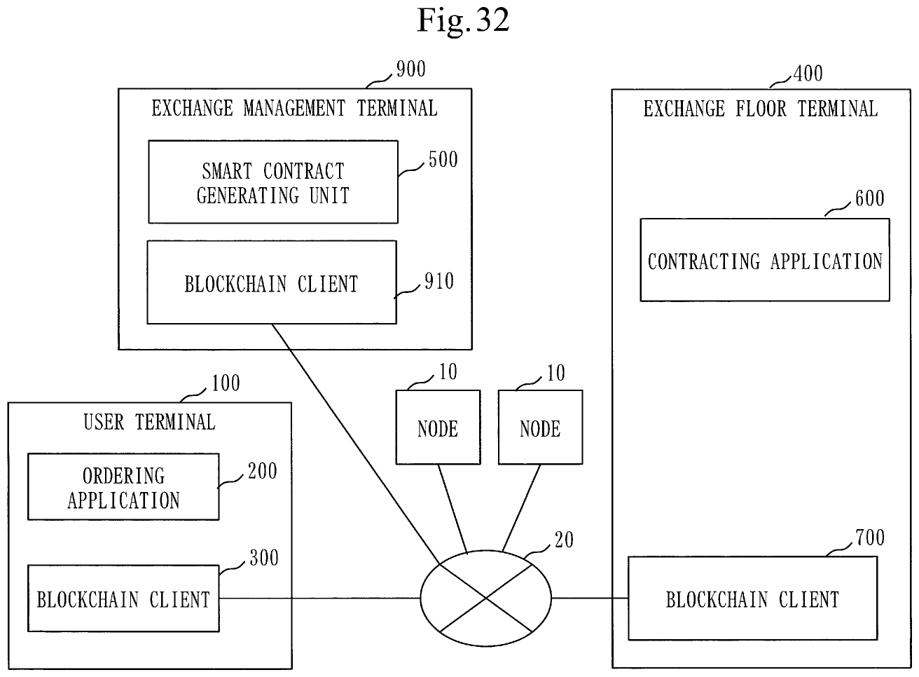

Then, an exchange managing terminal 900 is installed in the blockchain network 30 as with FIG. 32.

FIG. 32 illustrates the exchange managing terminal 900 that is connected to the blockchain network 30.

The smart contract 800 is validated to be authentic by the exchange managing terminal 900 that is the exchange managing device validated to be authentic. That is, the virtual-bond collecting program is validated to be authentic by the exchange managing terminal 900 that is the exchange managing device.

The exchange managing terminal 900 of the reliable exchange managing organization guarantees the smart contract 800, and registers the smart contract 800 in the blockchain 710. The user and the exchange floor use the smart contract 800 that the exchange managing terminal 900 has registered, and perform the exchange.

Since the owner of the smart contract 800 is the exchange managing organization, it is possible to perform a reliable exchange.

Further, a bond may be issued for each exchange floor for the shortage of the deposit on the exchange floor. However, by issuing the bond by the exchange managing organization, the bond can be collected not on an exchange floor basis but on an entire exchange basis. For example, if a bond is issued to the user U1 on an exchange floor 1 and a bond is issued to the user U2 on an exchange floor 2 respectively, the bond of user U1 can be collected first if the user U1 becomes a creditor first and there is the currency-putting-in on the exchange floor 2.

### REFERENCE SIGNS LIST

10: node, 20: internet, 30: blockchain network, 100: user terminal, 200: ordering application, 210: ordering unit, 211: order inputting unit, 212: order sending unit, 213: canceling unit, 220: exchange history unit, 221: exchange history acquiring unit, 222: exchange history displaying unit, 223: history viewing unit, 230: refunding unit, 300: blockchain client, 400: exchange floor terminal, 500: smart contract generating unit, 600: contracting application, 610: contracting unit, 611: order acquiring unit, 612: contract inputting unit, 613: contract sending unit, 620: exchange setting unit 621: setting inputting unit, 622: setting sending unit, 630: exchange history unit, 631: exchange history acquiring unit, 632: exchange history displaying unit, 640: depositing unit, 641: put-in-currency amount inputting unit, 642: put-in-currency sending unit, 643: currency-taking-out amount inputting unit, 644: taken-out-currency sending unit, 700: blockchain client, 710: blockchain, 800: smart contract, 810: user request receiving unit, 811: ordering unit, 811A: account registering unit. 811B: order registering unit, 812: canceling unit, 813 refunding unit, 814: applying unit, 820: exchange floor request receiving unit, 821: contracting unit, 822: exchange setting unit, 823: currency-putting-in unit, 824: currency-taking-out unit, 830: settling unit, 831: sending unit, 832: bond issuing unit, 833: bond collecting unit, 840: exchange history outputting unit, 850: process completion notifying unit, 900: exchange managing terminal, 910: blockchain client, 920: processor, 930: main storage device, 940: auxiliary storage device, 950: input/output interface, 951: inputting device 952: displaying device, 960: network interface, 970: signal line, 981 and 982: frame, D100: data, D110: management data, D111: temporary currency wallet, D112: refund wallet, D113: bond wallet, D114: exchange history, D130: management data for exchange floor, D131: deposit wallet, D132: user list, D133: creditor list, D140: exchange setting data, D141: selling and buying cost, D142: contract due time.

1. A virtual-bond collecting device comprising:
processing circuitry
to detect currency-putting-in of contract currency of buying contract by purchase of a commodity by a first user that has purchased the commodity from an exchange floor; and
to:
when the currency-putting-in of the contract currency of the buying contract by the purchase of the commodity by the first user is detected,
refer to creditor information in which a second user that is a creditor that has a virtual bond which is electronic data that the exchange floor has issued is managed, and
pay back to the second user, at least a part of a currency amount indicated by the virtual bond by using the contract currency of the first user.

2. The virtual-bond collecting device according to claim 1,
wherein the processing circuitry detects as the currency-putting-in of virtual currency, currency-pulling-in of virtual currency that a buyer pays to a seller.

3. The virtual-bond collecting device according to claim 1,
wherein the processing circuitry selects the creditor from the creditor information, and pays back to the selected creditor, at least a part of a currency amount indicated by the virtual bond.

4. The virtual-bond collecting device according to claim 2,
wherein the processing circuitry selects the creditor from the creditor information, and pays back to the selected creditor, at least a part of a currency amount indicated by the virtual bond.

5. The virtual-bond collecting device according to claim 1,
wherein the processing circuitry compares payment data indicating a payment amount to be paid by a buyer to a seller with deposit data indicating a deposit amount that the buyer has, issues the virtual bond to the seller based on a comparison result, and registers in the creditor information, the seller to which the virtual bond has been issued.

6. The virtual-bond collecting device according to claim 2,
wherein the processing circuitry compares payment data indicating a payment amount to be paid by a buyer to a seller with deposit data indicating a deposit amount that the buyer has, issues the virtual bond to the seller based on a comparison result, and registers in the creditor information, the seller to which the virtual bond has been issued.

7. The virtual-bond collecting device according to claim 3,
wherein the processing circuitry compares payment data indicating a payment amount to be paid by a buyer to a seller with deposit data indicating a deposit amount that the buyer has, issues the virtual bond to the seller based on a comparison result, and registers in the creditor information, the seller to which the virtual bond has been issued.

8. The virtual-bond collecting device according to claim 4,
wherein the processing circuitry compares payment data indicating a payment amount to be paid by a buyer to a seller with deposit data indicating a deposit amount that the buyer has, issues the virtual bond to the seller based on a comparison result, and registers in the creditor information, the seller to which the virtual bond has been issued.

9. The virtual-bond collecting device according to claim 1,
wherein the processing circuitry acquires an application of exchange details from a user, and writes the acquired application into a distributed ledger which is electronic data.

10. The virtual-bond collecting device according to claim 2,
wherein the processing circuitry acquires an application of exchange details from a user, and writes the acquired application into a distributed ledger which is electronic data.

11. The virtual-bond collecting device according to claim 3,
wherein the processing circuitry acquires an application of exchange details from a user, and writes the acquired application into a distributed ledger which is electronic data.

12. The virtual-bond collecting device according to claim 4,
wherein the processing circuitry acquires an application of exchange details from a user, and writes the acquired application into a distributed ledger which is electronic data.

13. The virtual-bond collecting device according to claim 5,
wherein the processing circuitry acquires an application of exchange details from a user, and writes the acquired application into a distributed ledger which is electronic data.

14. The virtual-bond collecting device according to claim 6,
wherein the processing circuitry acquires an application of exchange details from a user, and writes the acquired application into a distributed ledger which is electronic data.

15. The virtual-bond collecting device according to claim 7,
wherein the processing circuitry acquires an application of exchange details from a user, and writes the acquired application into a distributed ledger which is electronic data.

16. The virtual-bond collecting device according to claim 8,
wherein the processing circuitry acquires an application of exchange details from a user, and writes the acquired application into a distributed ledger which is electronic data.

17. A non-transitory computer readable medium storing a virtual-bond collecting program which causes a computer to execute:
a settling process of detecting currency-putting-in of contract currency of buying contract by purchase of a commodity by a first user that has purchased the commodity from an exchange floor, and
a virtual-bond collecting process of:
when the currency-putting-in of the contract currency of the buying contract by the purchase of the commodity by the first user is detected,
referring to creditor information in which a second user that is a creditor that has a virtual bond which is electronic data that the exchange floor has issued is managed, and
paying back to the second user, at least a part of a currency amount indicated by the virtual bond by using the contract currency of the first user.

18. The non-transitory computer readable medium storing the virtual-bond collecting program according to claim 17 being validated to be authentic by an exchange management device that manages an exchange.

19. A virtual-bond collecting method comprising:
detecting currency-putting-in of contract currency of buying contract by purchase of a commodity by a first user that has purchased the commodity from an exchange floor; and
when the currency-putting-in of the contract currency of the buying contract by the purchase of the commodity by the first user is detected,
referring to creditor information in which a second user that is a creditor that has a virtual bond which is electronic data that the exchange floor has issued is managed, and
paying back to the second user, at least a part of a currency amount indicated by the virtual bond by using the contract currency of the first user.
